(19) United States
(12) Patent Application Publication
(10) Pub. No.: US 2006/0142111 A1
(43) Pub. Date: Jun. 29, 2006

(54) Powertrain of an automatic transmission

(76) Inventor: Dong Hoon Park, Seongnam-city (KR)

Correspondence Address: Richard P. Berg;Ladas & Parry, Suite 2100, 5670 Wilshire Boulevard, Los Angeles, CA, 90036, US

(21) Appl. No.: 11/093,598

(22) Filed: Mar. 29, 2005

(30) Foreign Application Priority Data
Dec. 24, 2004 (KR) 10-2004-0112168

(51) Int. Cl. F16H 3/44

(52) U.S. Cl. 475/269

(57) ABSTRACT

A compound planetary gear set is designed to have first and second planetary gear sets gear-meshed with each other and respectively disposed on primary and secondary input shafts, and multi-stage shifting is realized by operating operational members of such a compound planetary gear set according to a predetermined operational chart. As a result, length of an automatic transmission may be reduced and durability may be increased.

### CROSS-REFERENCE TO RELATED APPLICATION

This application claims priority to and the benefit of Korean Patent Application 10-2004-0112168 filed in the Korean Intellectual Property Office on Dec. 24, 2004, the entire content of which is incorporated herein by reference.

### BACKGROUND OF THE INVENTION

(a) Field of the Invention

The present invention relates to an automatic transmission, and more particularly, to a powertrain of an automatic transmission.

(b) Description of the Related Art

A multi-stage gearshift mechanism of an automatic transmission includes a plurality of planetary gearsets. A powertrain having such a plurality of planetary gearsets varies the torque in multi-stages and outputs it to an output shaft when receiving a converted engine torque from a torque converter.

The more speeds the powertrain of an automatic transmission has, the better the power performance and fuel consumption. Therefore, it is desirable to have as many speeds as possible in powertrains.

Even for the same number of speeds, durability, power transmission efficiency, and size/weight of a transmission are substantially dependent on how planetary gearsets are arranged. Therefore, research for more structural strength, less power loss, and more compact packaging are under continuing investigation.

Usually, development of a powertrain using planetary gearsets does not devise a wholly new type of planetary gearsets. To the contrary, it invokes how single/double pinion planetary gear sets are combined, and how clutches, brakes, and one-way clutches are disposed to the combination of planetary gearsets such that required shift speeds and speed ratios are realized with minimal power loss.

As for a manual transmission, too many speeds cause a driver the inconvenience of excessive manual shifting. However, for an automatic transmission, a transmission control unit automatically executes shifting by controlling the operation of the power train, and therefore, more speeds usually implies more merits.

Accordingly, research of four-speed and five-speed powertrains has been undertaken, and recently, a powertrain of an automatic transmission enabling six forward speeds and one reverse speed has been developed.

An example of such research may be found in a powertrain of an automatic transmission disclosed in U.S. Pat. No. 5,106,352 (Lepelletier).

As shown in FIG. 36, such an exemplary powertrain disclosed in U.S. Pat. No. 5,106,352 (Lepelletier) includes a combination of one single pinion simple planetary gearset SPG in the front and one Ravingneaux planetary gearset RPG of a Ravingneaux type in the rear. A first sun gear S1 of the single pinion simple planetary gearset SPG is fixed to a transmission case 1, and a second ring gear R2 (or equivalently, a third ring gear R3) of the Ravingneaux planetary gearset RPG is connected to an output gear OUT such that it acts as an output element.

In addition, a first ring gear R1 of the simple planetary gearset SPG is fixedly connected to an input shaft 3, and a third planet carrier PC3 interconnecting second and third planetary gears P2 and P3 of the Ravingneaux planetary gearset RPG is variably connected to the input shaft 3 interposing a second clutch C2.

In addition, a first planet carrier PC1 carrying first planetary gear P1 of the single pinion simple planetary gearset SPG is variably connected to a third sun gear S3 of the Ravingneaux planetary gearset RPG interposing a first clutch C1. In addition, the first planet carrier PC1 is variably connected to a second sun gear S2 interposing a third clutch C3.

The second sun gear S2 is connected to the transmission case 1 interposing a first brake B1. A third planet carrier PC3 carrying second and third planetary gears P2 and P3 of the Ravingneaux planetary gearset RPG is connected to the transmission case 1 interposing a second brake B2 and a one-way clutch OWC in parallel.

Such a powertrain is operated as shown in FIG. 37 to realize six forward speeds and one reverse speed. That is, the first clutch C1 and the one-way clutch OWC (or equivalently the second brake B2) operate in a first forward speed, the first clutch C1 and the first brake B1 operate in a second forward speed, the first clutch C1 and the third clutch C3 operate in a third speed, the first clutch C1 and the second clutch C2 operate in a fourth speed, the second and third clutches C2 and C3 operate in a fifth speed, the second clutch C2 and the first brake B1 operate in a sixth speed, and the third clutch C3 and the second brake B2 operate in a reverse speed.

Examples other than U.S. Pat. No. 5,106,352 (Lepelletier) may also be found in U.S. Patent Publication No. US2004/0014553A1 (Inventor: Ishimaru; assignee: JATCO Ltd.; Publication Date: Jan. 22, 2004) and U.S. Patent Publication No. US2002/0065164A1 (Inventor: Kato et al.; assignee: AISIN AW Co., Ltd.; Publication Date: May 30, 2002).

According to such exemplary powertrains of an automatic transmission, planetary gear sets used for shifting and their operational members are disposed on a same shaft, thereby lengthening the automatic transmission. Therefore, installability of an automatic transmission is deteriorated, especially for a front-wheel drive vehicle.

When a seven-speed or eight-speed powertrain is designed based on such a powertrain of an automatic transmission, a powertrain of seven or eight speeds becomes further lengthened.

According to such a powertrain of the prior art, frictional elements such as clutches and brakes are designed to be disposed at a radial exterior of planetary gear sets, for reducing an increase in length of the transmission. However, this results in an increase in diameter of a transmission case, and accordingly deteriorates installability in the longitudinal direction of a vehicle.

Furthermore, a diameter of a friction disk of a frictional element increases, and accordingly efficiency of an automatic transmission is deteriorated because drag loss increases while the frictional element is not operated.

The information disclosed in this Background of the Invention section is only for enhancement of understanding of the background of the invention, and therefore, unless explicitly described to the contrary, it should not be taken as an acknowledgement or any form of suggestion that this information forms the prior art that is already known in this country to a person of ordinary skill in the art.

### SUMMARY OF THE INVENTION

The present invention has been made in an effort to provide a powertrain of an automatic transmission having advantages of enhanced installability due to short length, and enhanced durability.

An exemplary powertrain of an automatic transmission according to an embodiment of the present invention includes a primary input shaft, a secondary input shaft disposed in parallel with the primary input shaft, and a compound planetary gear set. The compound planetary gear set includes first and second planetary gear sets respectively disposed on the primary and secondary input shafts, and forms a plurality of operational elements by externally gear-meshing a plural pairs of operational members of the first and second planetary gear sets.

Another exemplary powertrain of an automatic transmission according to an embodiment of the present invention includes a primary input shaft, a secondary input shaft disposed in parallel with the primary input shaft, an output shaft disposed in parallel with the primary and secondary input shafts, a compound planetary gear set, a speed reduction device, first, second, and third clutches, and first and second brakes.

The compound planetary gear set includes first and second planetary gear sets disposed on the primary and secondary input shafts, wherein the first and second planetary gear sets are externally gear-meshed with each other so as to form a plurality of operational element including first, second, third, and fourth operational elements. The speed reduction device reduces a rotation speed of the primary input shaft and selectively transmits the reduced speed to the second input shaft and an operational member of the compound planetary gear set. The first clutch transmits the reduced speed of the speed reduction device to the first operational element. The second clutch variably connects the third operational element and the primary input shaft. The third clutch transmits the reduced speed of the speed reduction device to the secondary input shaft. The first brake may stop the third operational element. The second brake may stop the fourth operational element.

The first planetary gear set may be formed as a single pinion planetary gear set having a first sun gear, a first planet carrier, and a first ring gear, and the second planetary gear set is a single pinion planetary gear set having a second sun gear, a second planet carrier, and a second ring gear, wherein the first planet carrier is externally gear-meshed with the second ring gear, and the first ring gear is externally gear-meshed with the second planet carrier.

In this case, the first sun gear may form the first operational element, the first planet carrier and the second ring gear may form the second operational element, the first ring gear and the second planet carrier may form the third operational element, and the second sun gear may form the fourth operational element.

The speed reduction device may include a third planetary gear set, a transfer drive gear, and a transfer driven gear. The third planetary gear set is disposed on the primary input shaft and includes a fixed element fixed to the transmission case, an input element receiving rotation speed of the primary input shaft, and an output element outputting reduced speed by interaction with the fixed element and the input element. The transfer drive gear is disposed on the primary input shaft. The transfer driven gear is disposed on the secondary input shaft and externally gear-meshed with the transfer drive gear.

As a first detailed example of the speed reduction device, the third planetary gear set may be formed as a single pinion planetary gear set having a third sun gear, a third ring gear, and a third planet carrier, wherein the third sun gear, the third ring gear, and the third planet carrier respectively act as the fixed element, the input element, and the output element, and the third planet carrier is variably connected to the first operational element via the first clutch.

As a second detailed example of the speed reduction device, the third planetary gear set may be formed as a single pinion planetary gear set having a third sun gear, a third ring gear, and a third planet carrier, wherein the third sun gear, the third ring gear, and the third planet carrier respectively act as the input element, the fixed element, and the output element, and the third planet carrier is variably connected to the first operational element via the first clutch.

As a third detailed example of the speed reduction device, the third planetary gear set may be formed as a double pinion planetary gear set having a third sun gear, a third ring gear, and a third planet carrier, wherein the third sun gear, the third ring gear, and the third planet carrier respectively act as an input element, an output element, and a fixed element, and the third ring gear is variably connected to the first operational element via the first clutch.

As a fourth detailed example of the speed reduction device, the third planetary gear set may be formed as a double pinion planetary gear set having a third sun gear, a third ring gear, and a third planet carrier, wherein the third sun gear, the third ring gear, and the third planet carrier respectively act as the fixed element, the output element, and the input element, and the third ring gear is variably connected to the first operational element via the first clutch.

The third clutch may be formed to variably connect the output element and the transfer drive gear, and the transfer driven gear may be fixed to the secondary input shaft.

The transfer drive gear may be fixedly connected to the output element, and the third clutch may variably connect the transfer driven gear and the secondary input shaft.

The transfer drive gear and the third planetary gear set may be disposed opposite to each other with respect to the first planetary gear set.

In a further embodiment, the transfer drive gear and the transfer driven gear may form a predetermined reduction ratio by a radius ratio thereof.

In this case, the third clutch may variably connect the primary input shaft and the transfer drive gear, and the transfer driven gear may be fixed to the secondary input shaft.

The speed reduction device may further include a fourth planetary gear set disposed on the secondary input shaft and externally gear-meshed with the transfer drive gear, and the third clutch may variably connect the primary input shaft and the transfer drive gear.

In this case, the fourth planetary gear set may be formed as a single pinion planetary gear set, wherein a sun gear of the fourth planetary gear set is fixedly connected to the transmission case, a planet carrier of the fourth planetary gear set is fixedly connected to the secondary input shaft, and a ring gear of the fourth planetary gear set forms the transfer driven gear on an exterior circumference thereof.

Such various schemes of a powertrain may be altered to form seven-speeds or eight-speeds by adding one or more additional elements.

For example, such a powertrain may further include a final drive gear for outputting rotation speed of an operational member of the compound planetary gear set, and a final driven gear for driving a differential by being disposed on the output shaft and being engaged with the final drive gear.

In addition, such a powertrain may further include a first output mediating gear disposed on the output shaft and externally gear-meshed with one of the transfer driven gear and the third operational element, and a fourth clutch variably connecting the first output mediating gear and the final driven gear.

In this case, the first output mediating gear may be engaged with the transfer driven gear.

Furthermore, such a powertrain may further include a second output mediating gear disposed on the output shaft and externally gear-meshed with the third operational element, and a fifth clutch variably connecting the second output mediating gear and the final driven gear.

A speed reduction device may be formed different from the various exemplary powertrains described above. That is, the speed reduction device may include a transfer drive gear disposed on the primary input shaft, a transfer driven gear disposed on the secondary input shaft and externally gear-meshed with the transfer drive gear, a mediating drive gear disposed on the secondary input shaft and fixedly connected to the transfer driven gear, and a mediating driven gear disposed on the primary input shaft and externally gear-meshed with the mediating drive gear, wherein the first clutch variably connects the mediating driven gear and the first operational element, and the third clutch variably connects the secondary input shaft and one of the transfer driven gear and the mediating drive gear.

Such a powertrain may further include a final drive gear for outputting rotation speed of an operational member of the compound planetary gear set, and a final driven gear for driving a differential by being disposed on the output shaft and being engaged with the final drive gear.

Such a powertrain may realize seven forward speeds by further including a first output mediating gear disposed on the output shaft and externally gear-meshed with one of the transfer driven gear and the mediating drive gear, and a fourth clutch variably connecting the first output mediating gear and the final driven gear. The first output mediating gear may be engaged with the mediating drive gear.

Such a powertrain may realize eight forward speeds by further including a second output mediating gear disposed on the output shaft and externally gear-meshed with the transfer driven gear, and a fifth clutch variably connecting the second output mediating gear and the final driven gear.

Furthermore, a speed reduction device may be formed different from the various exemplary powertrains described above. That is, the speed reduction device may includes a transfer drive gear disposed on the primary input shaft, a mediating driven gear disposed on the primary input shaft, and a fourth planetary gear set. The fourth planetary gear set forms a transfer driven gear and a mediating drive gear, wherein the transfer driven gear is disposed on the secondary input shaft and externally gear-meshed with the transfer drive gear, and the mediating drive gear is externally gear-meshed with the mediating driven gear. In this case, the first clutch variably connects the mediating driven gear and the first operational element.

The fourth planetary gear set may be formed as a single pinion planetary gear set, wherein a sun gear of the fourth planetary gear set is fixedly connected to the transmission case, a planet carrier of the fourth planetary gear set protrudes in a radial direction so as to form the mediating drive gear, and a ring gear of the fourth planetary gear set forms the transfer driven gear on an exterior circumference thereof. In this case, the third clutch may variably connect the mediating drive gear and the secondary input shaft.

Such a powertrain may further include a final drive gear for outputting rotation speed of an operational member of the compound planetary gear set, and a final driven gear for driving a differential by being disposed on the output shaft and being engaged with the final drive gear.

Such a powertrain may realize seven forward speeds by further including a first output mediating gear disposed on the output shaft and externally gear-meshed with the mediating drive gear, and a fourth clutch variably connecting the first output mediating gear and the final driven gear.

Such a powertrain may realize eight forward speeds by further including a second output mediating gear disposed on the output shaft and externally gear-meshed with the transfer driven gear, and a fifth clutch variably connecting the second output mediating gear and the final driven gear.

Different from exemplary powertrains described above, the first planetary gear set may be formed as a double pinion planetary gear set having a first sun gear, a first planet carrier, and a first ring gear, and the second planetary gear set may be formed as a single pinion planetary gear set having a second sun gear, a second planet carrier, and a second ring gear, wherein the first ring gear is externally gear-meshed with the second ring gear, and the first planet carrier is externally gear-meshed with the second planet carrier.

In this case, the first sun gear may form the first operational element, the first and second ring gears may form the second operational element, the first and second planet carriers may form the third operational element, and the second sun gear may form the fourth operational element.

The speed reduction device may include a third planetary gear set disposed on the primary input shaft, a transfer drive gear disposed on the primary input shaft, and a transfer driven gear disposed on the secondary input shaft and externally gear-meshed with the transfer drive gear.

The third planetary gear set may be formed as a single pinion planetary gear set such that it includes a third sun gear fixedly connected to the transmission case, a third ring gear fixedly connected to the primary input shaft, and a third planet carrier variably connected to the first operational element via the first clutch. In this case, the third clutch may variably connect the third planet carrier and the transfer drive gear, and the transfer driven gear may be fixed to the secondary input shaft.

Otherwise, the third planetary gear set may be formed as a single pinion planetary gear set such that it includes a third ring gear fixedly connected to the transmission case, a third sun gear fixedly connected to the primary input shaft, and a third planet carrier variably connected to the first operational element via the first clutch. In this case, the third clutch may variably interconnect the third planet carrier and the transfer drive gear, and the transfer driven gear may be fixed to the secondary input shaft.

### BRIEF DESCRIPTION OF THE DRAWINGS

FIG. 1 is a schematic diagram of a powertrain of an automatic transmission according to a first embodiment of the present invention.

FIG. 2 is a schematic diagram of a powertrain of an automatic transmission according to a second embodiment of the present invention, and illustrates a first exemplary variation of the first embodiment.

FIG. 3 is a schematic diagram of a powertrain of an automatic transmission according to a third embodiment of the present invention, and illustrates a second exemplary variation of the first embodiment.

FIG. 4 is a schematic diagram of a powertrain of an automatic transmission according to a fourth embodiment of the present invention, and illustrates a third exemplary variation of the first embodiment.

FIG. 5 is a schematic diagram of a powertrain of an automatic transmission according to a fifth embodiment of the present invention.

FIG. 6 is a schematic diagram of a powertrain of an automatic transmission according to a sixth embodiment of the present invention, and illustrates a first exemplary variation of the fifth embodiment.

FIG. 7 is a schematic diagram of a powertrain of an automatic transmission according to a seventh embodiment of the present invention, and illustrates a second exemplary variation of the fifth embodiment.

FIG. 8 is a schematic diagram of a powertrain of an automatic transmission according to an eighth embodiment of the present invention, and illustrates a third exemplary variation of the fifth embodiment.

FIG. 9 is a schematic diagram of a powertrain of an automatic transmission according to a ninth embodiment of the present invention.

FIG. 10 is a schematic diagram of a powertrain of an automatic transmission according to a tenth embodiment of the present invention, and illustrates a first exemplary variation of the ninth embodiment.

FIG. 11 is a schematic diagram of a powertrain of an automatic transmission according to an eleventh embodiment of the present invention, and illustrates a second exemplary variation of the ninth embodiment.

FIG. 12 is a schematic diagram of a powertrain of an automatic transmission according to a twelfth embodiment of the present invention, and illustrates a third exemplary variation of the ninth embodiment.

FIG. 13 is a schematic diagram of a powertrain of an automatic transmission according to a thirteenth embodiment of the present invention.

FIG. 14 is a schematic diagram of a powertrain of an automatic transmission according to a fourteenth embodiment of the present invention, and illustrates a first exemplary variation of the thirteenth embodiment.

FIG. 15 is a schematic diagram of a powertrain of an automatic transmission according to a fifteenth embodiment of the present invention, and illustrates a second exemplary variation of the thirteenth embodiment.

FIG. 16 is a schematic diagram of a powertrain of an automatic transmission according to a sixteenth embodiment of the present invention, and illustrates a third exemplary variation of the thirteenth embodiment.

FIG. 17 is an operational chart for a powertrain of an automatic transmission according to the first to sixteenth embodiments of the present invention.

FIG. 18 illustrates a lever diagram and a speed diagram of a powertrain of an automatic transmission according to the first to sixteenth embodiments of the present invention.

FIG. 19 is a schematic diagram of a powertrain of an automatic transmission according to a seventeenth embodiment of the present invention, and illustrates an exemplary powertrain that realizes seven forward speeds and one reverse speed according to a variation of the second, sixth, tenth, and fourteenth embodiments of the present invention.

FIG. 20 is an operational chart for a powertrain of an automatic transmission according to the seventeenth embodiment of the present invention.

FIG. 21 is a schematic diagram of a powertrain of an automatic transmission according to an eighteenth embodiment of the present invention, and illustrates an exemplary powertrain that realizes eight forward speeds and one reverse speed according to a variation of the seventeenth embodiment of the present invention.

FIG. 22 is an operational chart for a powertrain of an automatic transmission according to an eighteenth embodiment of the present invention.

FIG. 23 is a schematic diagram of a powertrain of an automatic transmission according to a nineteenth embodiment of the present invention.

FIG. 24 is a schematic diagram of a powertrain of an automatic transmission according to a twentieth embodiment of the present invention, and illustrates an exemplary powertrain that realizes seven forward speeds and one reverse speed according to a variation of the nineteenth embodiment of the present invention.

FIG. 25 is an operational chart for a powertrain of an automatic transmission according to the twentieth embodiment of the present invention.

FIG. 26 is a schematic diagram of a powertrain of an automatic transmission according to a twenty-first embodiment of the present invention, and illustrates an exemplary powertrain that realizes eight forward speeds and one reverse speed according to a variation of the twentieth embodiment of the present invention.

FIG. 27 is an operational chart for a powertrain of an automatic transmission according to the twenty-first embodiment of the present invention.

FIG. 28 is a schematic diagram of a powertrain of an automatic transmission according to a twenty-second embodiment of the present invention.

FIG. 29 is a schematic diagram of a powertrain of an automatic transmission according to a twenty-third embodiment of the present invention, and illustrates an exemplary powertrain that realizes seven forward speeds and one reverse speed according to a variation of the twenty-second embodiment of the present invention.

FIG. 30 is an operational chart for a powertrain of an automatic transmission according to the twenty-third embodiment of the present invention.

FIG. 31 is a schematic diagram of a powertrain of an automatic transmission according to a twenty-fourth embodiment of the present invention, and illustrates an exemplary powertrain that realizes eight forward speeds and one reverse speed according to a variation of the twenty-third embodiment of the present invention.

FIG. 32 is an operational chart for a powertrain of an automatic transmission according to the twenty-fourth embodiment of the present invention.

FIG. 33 is a schematic diagram of a powertrain of an automatic transmission according to a twenty-fifth embodiment of the present invention.

FIG. 34 illustrates a lever diagram and a speed diagram of a powertrain of an automatic transmission according to the twenty-fifth embodiment of the present invention.

FIG. 35 is a schematic diagram of a powertrain of an automatic transmission according to a twenty-sixth embodiment of the present invention.

FIG. 36 is a schematic diagram of a powertrain of an automatic transmission according to the prior art.

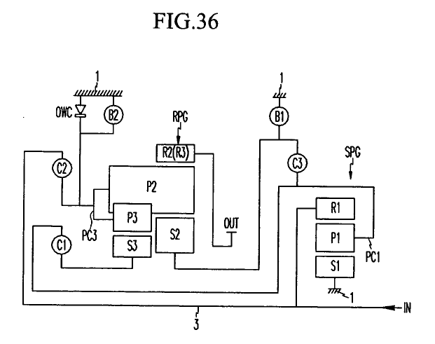

FIG. 37 is an operational chart for a powertrain shown in FIG. 36.

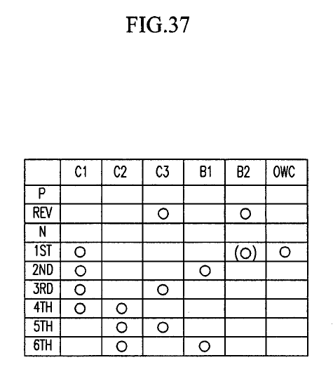

### DETAILED DESCRIPTION OF THE EMBODIMENTS

Hereinafter, embodiments of the present invention are described in detail with reference to the drawings.

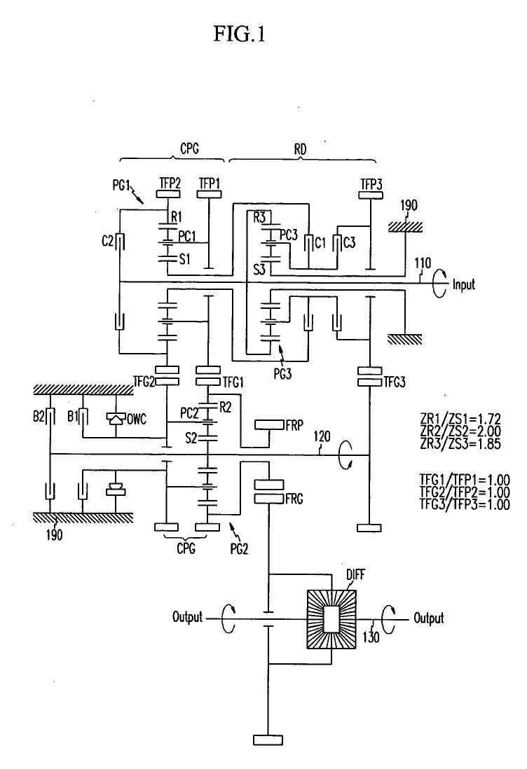

Firstly, a powertrain of an automatic transmission according to a first embodiment of the present invention is described in detail with reference to FIG. 1.

As shown in FIG. 1, a powertrain of an automatic transmission according to the first embodiment of the present invention includes a primary input shaft 110, a secondary input shaft 120, an output shaft 130, a compound planetary gear set CPG, and a speed reduction device RD.

The automatic transmission receives torque from an engine (not shown) through the primary input shaft 110, e.g., via a torque converter (not shown). The secondary input shaft 120 is disposed in parallel with the primary input shaft 110. The output shaft 130 is disposed in parallel with the primary input shaft 110 and the secondary input shaft 120.

The compound planetary gear set CPG includes a first planetary gear set PG1 disposed on the primary input shaft 110 and a second planetary gear set PG2 disposed on the secondary input shaft 120.

The first planetary gear set PG1 is a single pinion planetary gear set having its planetary gear members of a first sun gear S1, a first planet carrier PC1, and a first ring gear R1. The second planetary gear set PG2 is a single pinion planetary gear set having its planetary gear members of a second sun gear S2, a second planet carrier PC2, and a second ring gear R2.

The first sun gear S1 is rotatably disposed on the primary input shaft 110, and the second sun gear S2 is fixed to the secondary input shaft 120 such that it rotates with the secondary input shaft 120.

The first and second planetary gear sets PG1 and PG2 are externally gear-meshed, and therefore the compound planetary gear set CPG forms first, second, third, and fourth operational elements sequentially in a speed diagram. In more detail, the first and second planetary gear sets PG1 and PG2 respectively include three planetary gear members, however two pairs of planetary gear members are fixedly connected by being externally gear-meshed. Therefore, the compound planetary gear set CPG forms four operational elements in total. Hereinafter, such four operational elements are referred to as first, second, third, and fourth operational elements N1, N2, N3, and N4 according to a consecutive order shown in the speed diagram.

In more detail, the first planet carrier PC1 is externally gear-meshed with the second ring gear R2, and the first ring gear R1 is externally gear-meshed with the second planet carrier PC2.

That is, external gears TFP1 and TFG1 are respectively formed on exterior circumferences of the first planet carrier PC1 and the second ring gear R2, and the two external gears TFP1 and TFG1 are externally gear-meshed. In addition, external gears TFP2 and TFG2 are respectively formed on exterior circumferences of the first ring gear R1 and the second planet carrier PC2, and the two external gears TFP2 and TFG2 are externally gear-meshed.

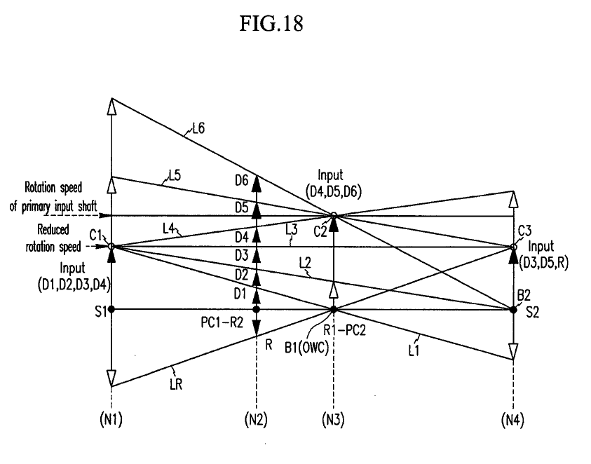

Therefore, as shown in FIG. 18, according to a powertrain of an automatic transmission according to the first embodiment of the present invention, the first sun gear S1 forms the first operational element N1, the first planet carrier PC1 and the second ring gear R2 that are externally gear-meshed form the second operational element N2, the first ring gear R1 and the second planet carrier PC2 that are externally gear-meshed thereto form the third operational element N3, and the second sun gear S2 forms the fourth operational element N4.

The speed reduction device RD reduces a rotation speed of the primary input shaft 110 and selectively outputs the reduced speed to the secondary input shaft 120 and an operational member of the compound planetary gear set CPG.

In more detail, the speed reduction device RD includes the third planetary gear set PG3 disposed on the primary input shaft 110, a transfer drive gear TFP3 disposed on the primary input shaft 110, and a transfer driven gear TFG3 disposed on the secondary input shaft 120 and being externally gear-meshed with the transfer drive gear TFP3.

The third planetary gear set PG3 is formed as a single pinion planetary gear set including a third sun gear S3, a third planet carrier PC3, and a third ring gear R3.

The third sun gear S3 is fixedly connected to a transmission case 190. The third ring gear R3 is fixedly connected to the primary input shaft 110.

Therefore, the rotation speed of the primary input shaft 110 received at the third ring gear R3 is reduced at the third planetary gear set PG3 and output through the third planet carrier PC3.

The third planet carrier PC3 is variably connected to the first operational element N1 (i.e., the first sun gear S1) via a first clutch C1. Therefore, the reduced speed of the speed reduction device RD is selectively delivered to the first operational element N1 by the operation of the first clutch C1.

The third operational element N3 (in more detail, the first ring gear R1) is variably connected to the primary input shaft 110 via a second clutch C2.

The third clutch C3 delivers the reduced speed of the speed reduction device RD to the secondary input shaft 120. For such an operation, according to a powertrain of an automatic transmission of the first embodiment of the present invention, the third clutch C3 variably interconnects the third planet carrier PC3 and the transfer drive gear TFP3, and the transfer driven gear TFG3 is fixed to the secondary input shaft 120.

The second operational element N2 (in more detail, the second ring gear R2) is fixedly connected to the final drive gear FRP, and always acts as an output element of the compound planetary gear set CPG.

The final driven gear FRG engaged with the final drive gear FRP is rotatably disposed on the output shaft 130. A differential DIFF is fixedly connected to the output shaft 130. The final driven gear FRG is fixedly connected to the differential DIFF, and accordingly, the differential DIFF (resultantly, the output shaft 130) is driven by a torque of the final driven gear FRG.

The third operational element N3 (in more detail, the second planet carrier PC2) is variably connected to the transmission case 190 via the first brake B1. Therefore, the third operational element N3 may be stopped by the operation of the first brake B1.

According to an embodiment of the present invention, a one-way clutch OWC is disposed in parallel with the first brake B1. Therefore, even if the first brake B1 is not actively operated, the third operational element N3 may be stopped by the functioning of the one-way clutch OWC. According to a powertrain of an embodiment of the present invention, for an engine brake effect, the first brake B1 is actively operated.

In addition, the fourth operational element N4 (in more detail, the second sun gear S2) is variably connected to the transmission case 190 via the second brake B2. Therefore, the fourth operational element N4 may be stopped by the operation of the second brake B2.

As a result, the first operational element N1 rotates at the reduced speed when the first clutch C1 operates. The second operational element N2 always acts as an output element. The third operational element N3 may be stopped by the operation of the first brake B1, or may rotate at the rotation speed of the primary input shaft 110 by the operation of the second clutch C2. The fourth operational element N4 may be stopped by the operation of the second brake B2, or may rotate at the reduced speed of third planetary gear set PG3 by the operation of the third clutch C3.

In a powertrain of an automatic transmission according to the first embodiment of the present invention, ring gear/sun gear tooth ratios of the first, second, and third planetary gear sets PG1, PG2, and PG3 are exemplarily formed as follows. That is, the ring gear/sun gear tooth ratio is formed as 1.72 for the first planetary gear set PG1, 2.0 for the second planetary gear set PG2, and 1.85 for the third planetary gear set PG3.

In addition, the external gear TFP1 of the first planet carrier PC1 and the external gear TFG1 of the second ring gear R2 have equal radii. The external gear TFP2 of the first ring gear R1 and the external gear TFG2 of the second planet carrier PC2 also have equal radii. In addition, the transfer drive gear TFP3 and the transfer driven gear TFG3 have equal radii.

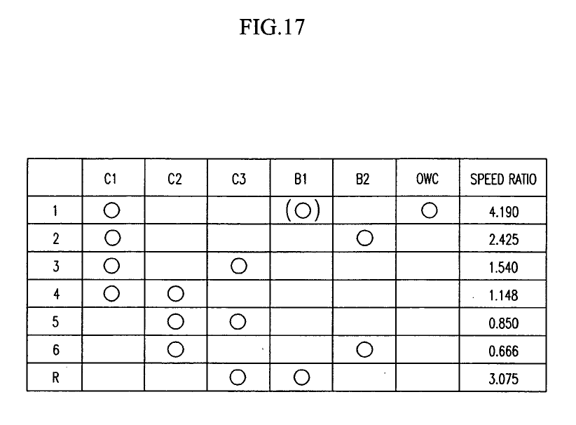

Such a powertrain of an automatic transmission according to the first embodiment of the present invention realizes six forward speeds and one reverse speed by operation according to the operational chart shown in FIG. 17.

That is, at the first forward speed, the first clutch C1 operates. In this case, when engine power is received through the primary input shaft 110, rotation of the third operational element N3 is blocked by the function of the one-way clutch OWC and accordingly the third operational element N3 becomes stopped. At such a first forward speed, the first brake B1 may be actively operated for an engine brake effect. For better comprehension of the spirit of the present invention, the first brake B1 is described to operate at the first forward speed in the following description.

At the second forward speed, the first clutch C1 and the second brake B2 operate. At the third forward speed, the first clutch C1 and the third clutch C3 operate. At the fourth forward speed, the first clutch C1 and the second clutch C2 operate. At the fifth forward speed, the second clutch C2 and the third clutch C3 operate. At the sixth forward speed, the second clutch C2 and the second brake B2 operate. At the reverse speed, the third clutch C3 and the first brake B1 operate.

Therefore, for shifting from the first forward speed to the second forward speed, the first brake B1 is released and the second brake B2 operates from the first forward speed.

For shifting from the second forward speed to the third forward speed, the second brake B2 is released and the third clutch C3 operates from the second forward speed.

For shifting from the third forward speed to the fourth forward speed, the third clutch C3 is released and the second clutch C2 operates from the third forward speed. For shifting from the fourth forward speed to the fifth forward speed, the first clutch C1 is released and the third clutch C3 operates from the fourth forward speed.

For shifting from the fifth forward speed to the sixth forward speed, the third clutch C3 is released and the second brake B2 operates from the fifth forward speed.

Hereinafter, realization of six forward speeds and a reverse speed by operations of such first, second, and third clutches C1, C2, and C3 and first and second brakes B1 and B2 is described in detail with reference with FIG. 18.

As described above, the first clutch C1 and the first brake B1 operate at the first forward speed.

Therefore, the first operational element N1 rotates at the reduced rotation speed of the speed reduction device RD by the operation of the first clutch C1, and the third operational element N3 stops by the operation of the first brake B1.

Therefore, in such a first forward speed, the speed line of the compound planetary gear set CPG is formed as L1 in FIG. 18, and accordingly, the output element of the second operational element N2 rotates at a speed D1 and outputs its speed.

At the second forward speed, the first operational element N1 remains rotating at the reduced rotation speed since the first clutch C1 remains operating, and the fourth operational element N4 stops by the operation of the second brake B2.

Therefore, in such a second forward speed, the speed line of the compound planetary gear set CPG is formed as L2 of FIG. 18, and accordingly, the output element of the second operational element N2 rotates at a speed D2 and outputs its speed.

At the third forward speed, the first operational element N1 remains rotating at the reduced rotation speed since the first clutch C1 remains operating, and the fourth operational element N4 also rotates at the reduced rotation speed by the operation of the third clutch C3.

Therefore, in such a third forward speed, the speed line of the compound planetary gear set CPG is formed as L3 of FIG. 18, and accordingly, the output element of the second operational element N2 rotates at a speed D3 and outputs its speed.

At the fourth forward speed, the first operational element N1 remains rotating at the reduced rotation speed since the first clutch C1 remains operating, and the third operational element N3 rotates at a rotation speed of the primary input shaft 110 by the operation of the second clutch C2.

Therefore, in such a fourth forward speed, the speed line of the compound planetary gear set CPG is formed as L4 of FIG. 18, and accordingly, the output element of the second operational element N2 rotates at a speed D4 and outputs its speed.

At the fifth forward speed, the third operational element N3 remains rotating at the rotation speed of the primary input shaft 110 since the second clutch C2 remains operating, and the fourth operational element N4 rotates at the reduced rotation speed by the operation of the third clutch C3.

Therefore, in such a fifth forward speed, the speed line of the compound planetary gear set CPG is formed as L5 of FIG. 18, and accordingly, the output element of the second operational element N2 rotates at a speed D5 and outputs its speed.

At the sixth forward speed, the third operational element N3 remains rotating at the rotation speed of the primary input shaft 110 since the second clutch C2 remains operating, and the fourth operational element N4 stops by the operation of the second brake B2.

Therefore, in such a sixth forward speed, the speed line of the compound planetary gear set CPG is formed as L6 of FIG. 18, and accordingly, the output element of the second operational element N2 rotates at a speed D6 and outputs its speed.

At the reverse speed, the fourth operational element N4 rotates at the reduced rotation speed by the operation of the third clutch C3, and the third operational element N3 stops by the operation of the first brake B1.

Therefore, in such a reverse speed, the speed line of the compound planetary gear set CPG is formed as LR of FIG. 18, and accordingly, the output element of the second operational element N2 rotates at a speed R (i.e., negative speed) and outputs its speed.

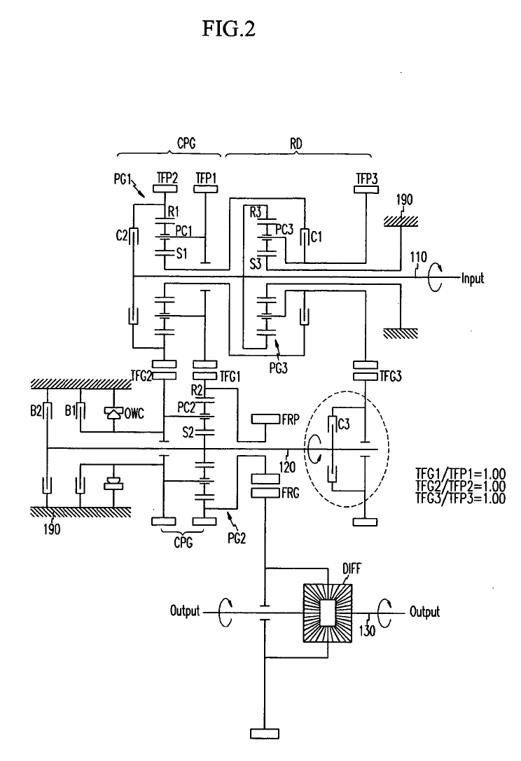

Hereinafter, a powertrain of an automatic transmission according to a second embodiment of the present invention is described in detail with reference to FIG. 2.

As shown in FIG. 2, a powertrain of an automatic transmission according to the second embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the first embodiment.

However, regarding the speed reduction device RD of the present embodiment, connection of the third clutch C3 differs from the first embodiment.

That is, regarding the speed reduction device RD of the present embodiment, the transfer drive gear TFP3 is fixedly connected to the third planet carrier PC3, and the third clutch C3 variably connects the transfer driven gear TFG3 and the secondary input shaft 120.

Therefore, the transfer drive gear TFP3 always rotates at the reduced rotation speed output from the third planet carrier PC3, and accordingly, the transfer driven gear TFG3 also always rotates at the reduced rotation speed. In this case, the transfer driven gear TFG3 is variably connected to the secondary input shaft 120 via the third clutch C3, and accordingly, the secondary input shaft 120 rotates at the reduced rotation speed by the operation of the third clutch C3. Therefore, according to such arrangement of the third clutch C3, the same as in the first embodiment, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

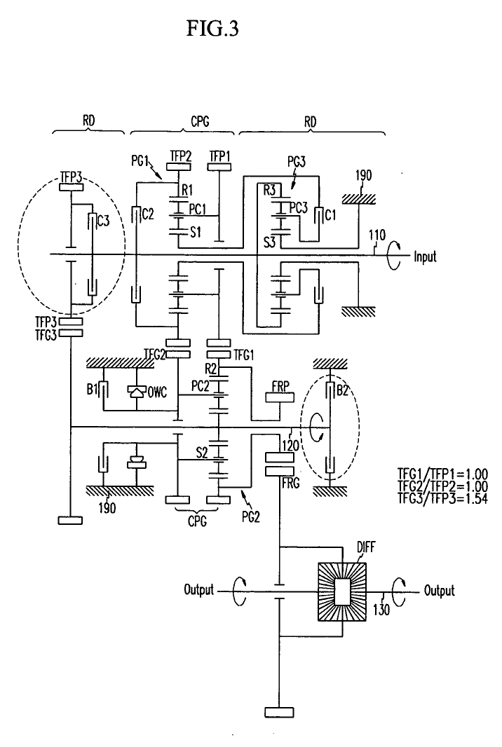

Hereinafter, a powertrain of an automatic transmission according to a third embodiment of the present invention is described in detail with reference to FIG. 3.

As shown in FIG. 3, a powertrain of an automatic transmission according to the third embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the first embodiment.

However, regarding the speed reduction device RD of the present embodiment, arrangement of the transfer drive gear TFP3 and the transfer driven gear TFG3 and connection of the third clutch C3 differ from the first embodiment.

An arrangement of the second brake B2 also differs from the first embodiment. However, such a difference is only for an optimal layout of a powertrain, and it should be noted that the second brake B2 may also be arranged in the same way as in the first embodiment.

Regarding the speed reduction device RD of the present embodiment, the transfer drive gear TFP3 and the transfer driven gear TFG3 are disposed opposite to the third planetary gear set PG3 with respect to the first planetary gear set PG1.

In the first embodiment, the transfer drive gear TFP3 is variably connected to the third planet carrier PC3 via the third clutch C3. However, according to the present embodiment, the transfer drive gear TFP3 is connected to the primary input shaft 110 via the third clutch C3. In addition, the transfer driven gear TFG3 is fixed to the secondary input shaft 120.

The transfer drive and driven gears TFP3 and TFG3 are formed at a radius ratio corresponding to a predetermined reduction ratio such that reduced speed may be delivered to the secondary input shaft 120 by an operation of the third clutch C3. For example, the transfer driven gear TFG3 is 1.54 times larger than the transfer drive gear TFP3 in radius, and accordingly, the rotation speed of the primary input shaft 110 is reduced to 1/1.54 times and is delivered to the secondary input shaft 120.

Therefore, the secondary input shaft 120 rotates at the reduced rotation speed by the operation of the third clutch C3. So, according to the present embodiment, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

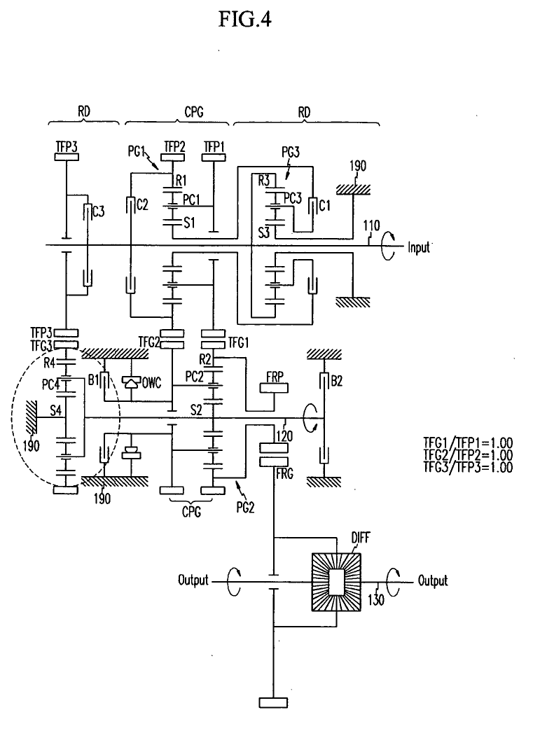

Hereinafter, a powertrain of an automatic transmission according to a fourth embodiment of the present invention is described in detail with reference to FIG. 4.

As shown in FIG. 4, a powertrain of an automatic transmission according to the fourth embodiment of the present invention is similar to a powertrain of an automatic transmission according to the third embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the third embodiment (equivalently, the first embodiment) of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the third embodiment (equivalently, the first embodiment). In addition, the third clutch C3 variably connects the primary input shaft 110 and the transfer drive gear TFP3, the same as in the third embodiment.

However, regarding the speed reduction device RD of the present embodiment, details of the transfer drive gear TFP3 and the transfer driven gear TFG3 differ from the third embodiment.

In more detail, the speed reduction device RD of the present embodiment further includes a fourth planetary gear set PG4 arranged on the secondary input shaft 120 and externally gear-meshed with the transfer drive gear TFP3.

Such a fourth planetary gear set PG4 is formed as a single pinion planetary gear set including a fourth sun gear S4, a fourth planet carrier PC4, and a fourth ring gear R4. The fourth sun gear S4 is fixedly connected to the transmission case 190. The fourth planet carrier PC4 is fixedly connected to the secondary input shaft 120. The fourth ring gear R4 is formed with the transfer driven gear TFG3 on its exterior circumference, and is externally gear-meshed with the transfer drive gear TFP3 through the transfer driven gear TFG3.

In addition, the transfer drive and driven gears TFP3 and TFG3 have equal radii, which is different from the third embodiment.

Therefore, when the third clutch C3 operates, the rotation speed of the primary input shaft 110 is delivered to the transfer driven gear TFG3 (i.e., the fourth ring gear R4) without any change through the transfer drive gear TFP3. In addition, the fourth planetary gear set PG4 reduces the rotation speed of the fourth ring gear R4 and outputs the reduced speed to the secondary input shaft 120 through the fourth planet carrier PC4.

Therefore, the secondary input shaft 120 rotates at the reduced rotation speed by the operation of the third clutch C3. So, according to the fourth embodiment, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

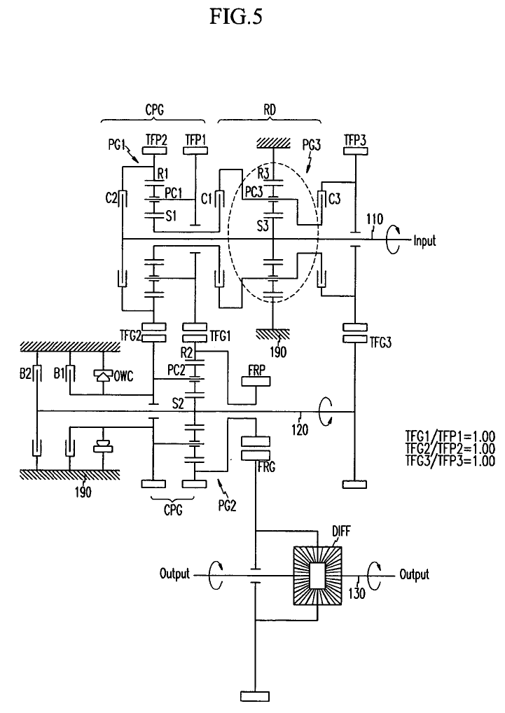

Hereinafter, a powertrain of an automatic transmission according to a fifth embodiment of the present invention is described in detail with reference to FIG. 5.

As shown in FIG. 5, a powertrain of an automatic transmission according to the fifth embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

The same as in the first embodiment, the speed reduction device RD of the present embodiment includes a third planetary gear set PG3, a transfer drive gear TFP3, and a transfer driven gear TFG3. An arrangement of the transfer drive gear TFP3 and the transfer driven gear TFG3 is also the same as in the first embodiment. The third planetary gear set PG3 is formed as a single pinion planetary gear set including a third sun gear S3, a third planet carrier PC3, and a third ring gear R3. In addition, the same in the first embodiment, the third planet carrier PC3 is variably connected to the transfer drive gear TFP3 via the third clutch C3.

However, according to the present embodiment, the third sun gear S3 and the third ring gear R3 of the third planetary gear set PG3 are connected to the transmission case 190 and the primary input shaft 110 in opposite manners in comparison with the first embodiment.

That is, according to the first embodiment, the primary input shaft 110 is fixedly connected to the third ring gear R3, and the third sun gear S3 is fixed to the transmission case 190. However, according to the present embodiment, the primary input shaft 110 is fixedly connected to the third sun gear S3, and the third ring gear R3 is fixed to the transmission case 190.

According to such connections, the rotation of the primary input shaft 110 is reduced at the third planet carrier PC3 and output therethrough. In addition, the reduced speed of the third planet carrier PC3 is transmitted to the transfer drive gear TFP3 by the operation of the third clutch C3. Therefore, the secondary input shaft 120 rotates at the reduced rotation speed by the operation of the third clutch C3. Therefore, according to such arrangement of the third clutch C3, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

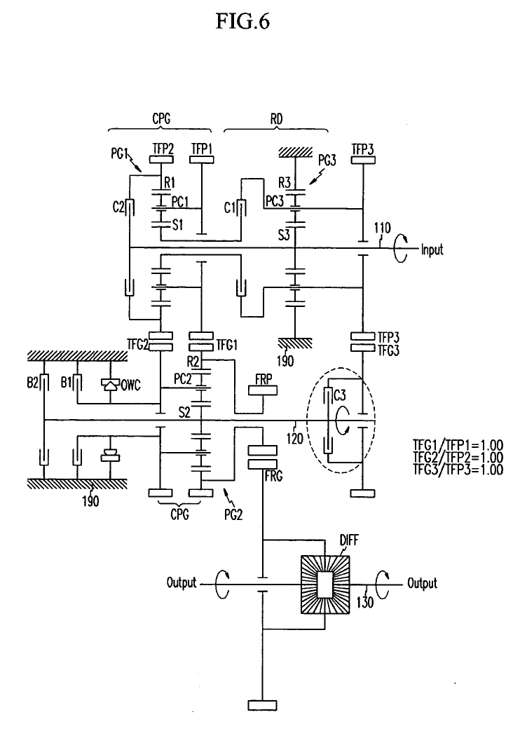

Hereinafter, a powertrain of an automatic transmission according to a sixth embodiment of the present invention is described in detail with reference to FIG. 6.

As shown in FIG. 6, a powertrain of an automatic transmission according to the sixth embodiment of the present invention is similar to a powertrain of an automatic transmission according to the fifth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the fifth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the fifth embodiment.

However, regarding the speed reduction device RD of the present embodiment, connection of the third clutch C3 differs from the fifth embodiment.

That is, regarding the speed reduction device RD of the present embodiment, the transfer drive gear TFP3 is fixedly connected to the third planet carrier PC3, and the third clutch C3 variably connects the transfer driven gear TFG3 and the secondary input shaft 120.

Therefore, the transfer drive gear TFP3 always rotates at the reduce rotation speed output from the third planet carrier PC3, and accordingly, the transfer driven gear TFG3 also always rotates at the reduced rotation speed. In this case, the transfer driven gear TFG3 is variably connected to the secondary input shaft 120 via the third clutch C3, and accordingly, the secondary input shaft 120 rotates at the reduced rotation speed by the operation of the third clutch C3. Therefore, according to such arrangement of the third clutch C3, the same as in the fifth embodiment, the fourth operational element N4 rotates at the reduced rotation speed by the operation of the third clutch C3.

Therefore, the same as in the fifth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

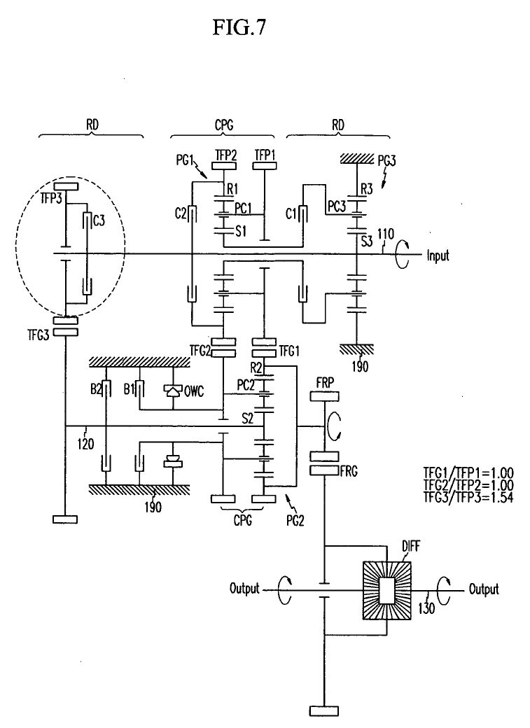

Hereinafter, a powertrain of an automatic transmission according to a seventh embodiment of the present invention is described in detail with reference to FIG. 7.

As shown in FIG. 7, a powertrain of an automatic transmission according to the seventh embodiment of the present invention is similar to a powertrain of an automatic transmission according to the fifth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the fifth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the fifth embodiment.

However, regarding the speed reduction device RD of the present embodiment, arrangement of the transfer drive gear TFP3 and the transfer driven gear TFG3 and connection of the third clutch C3 differ from the fifth embodiment.

That is, regarding the speed reduction device RD of the present embodiment, the transfer drive gear TFP3 and the transfer driven gear TFG3 are disposed opposite to the third planetary gear set PG3 with respect to the first planetary gear set PG1.

In the fifth embodiment, the transfer drive gear TFP3 is variably connected to the third planet carrier PC3 via the third clutch C3. However, according to the present embodiment, the transfer drive gear TFP3 is connected to the primary input shaft 110 via the third clutch C3. In addition, the transfer driven gear TFG3 is fixed to the secondary input shaft 120.

The transfer drive and driven gears TFP3 and TFG3 are formed at a radius ratio corresponding to a predetermined reduction ratio such that reduced speed may be delivered to the secondary input shaft 120 by an operation of the third clutch C3.

For example, the transfer driven gear TFG3 is 1.54 times larger than the transfer drive gear TFP3 in radius, and accordingly, the rotation speed of the primary input shaft 110 is reduced to 1/1.54 times and is delivered to the secondary input shaft 120.

Therefore, the secondary input shaft 120 rotates at the reduced rotation speed by the operation of the third clutch C3. So, according to the present embodiment, the same as in the fifth embodiment, the fourth operational element N4 rotates at the reduced rotation speed by the operation of the third clutch C3.

Therefore, the same as in the fifth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

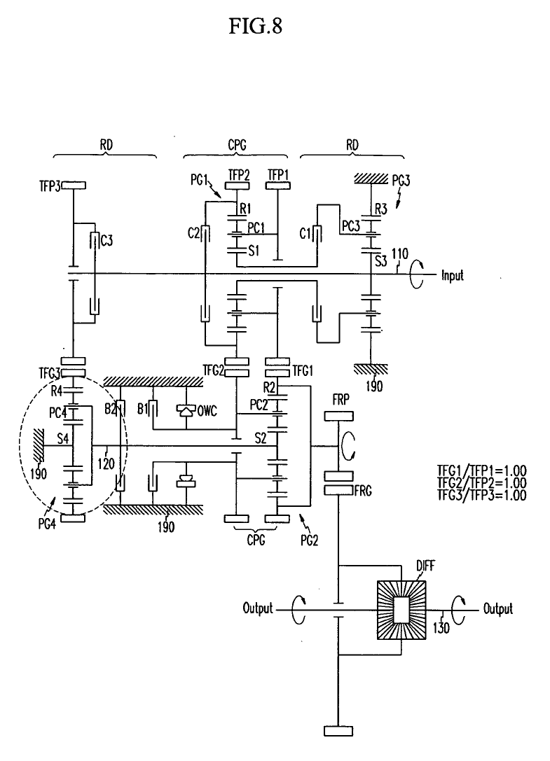

Hereinafter, a powertrain of an automatic transmission according to an eighth embodiment of the present invention is described in detail with reference to FIG. 8.

As shown in FIG. 8, a powertrain of an automatic transmission according to the eighth embodiment of the present invention is similar to a powertrain of an automatic transmission according to the seventh embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the seventh embodiment (equivalently, the fifth embodiment) of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the seventh embodiment (equivalently, the fifth embodiment). In addition, the third clutch C3 variably connects the primary input shaft 110 and the transfer drive gear TFP3, the same as in the seventh embodiment.

However, regarding the speed reduction device RD of the present embodiment, details of the transfer drive gear TFP3 and the transfer driven gear TFG3 differ from the seventh embodiment.

In more detail, the speed reduction device RD of the present embodiment further includes a fourth planetary gear set PG4 arranged on the secondary input shaft 120 and externally gear-meshed with the transfer drive gear TFP3.

Such a fourth planetary gear set PG4 is formed as a single pinion planetary gear set including a fourth sun gear S4, a fourth planet carrier PC4, and a fourth ring gear R4. The fourth sun gear S4 is fixedly connected to the transmission case 190. The fourth planet carrier PC4 is fixedly connected to the secondary input shaft 120. The fourth ring gear R4 is formed with the transfer driven gear TFG3 on its exterior circumference, and is externally gear-meshed with the transfer drive gear TFP3 through the transfer driven gear TFG3.

In addition, the transfer drive and driven gears TFP3 and TFG3 have equal radii, which is different from the seventh embodiment.

Therefore, when the third clutch C3 operates, the rotation speed of the primary input shaft 110 is delivered to the transfer driven gear TFG3 (i.e., the fourth ring gear R4) without any change through the transfer drive gear TFP3. In addition, the fourth planetary gear set PG4 reduces the rotation speed of the fourth ring gear R4 and outputs the reduced speed to the secondary input shaft 120 through the fourth planet carrier PC4.

Therefore, the secondary input shaft 120 rotates at the reduced rotation speed by the operation of the third clutch C3. So, according to the fourth embodiment, the same as in the fifth embodiment, the fourth operational element N4 rotates at the reduced rotation speed by the operation of the third clutch C3.

Therefore, the same as in the fifth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

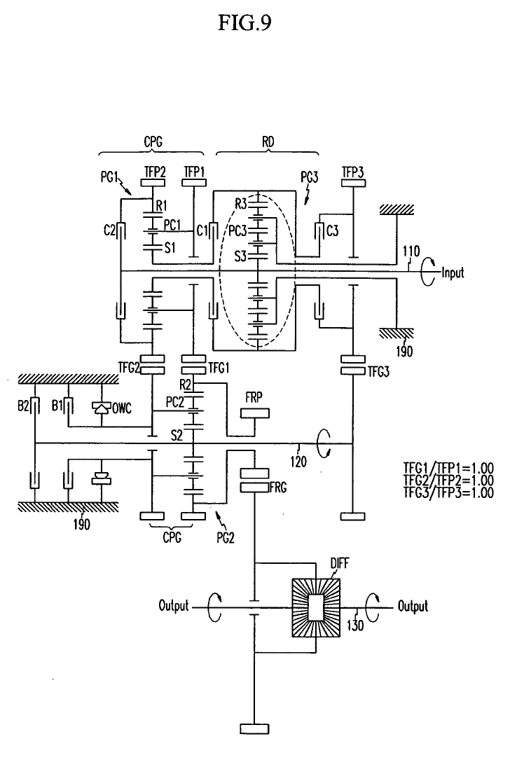

Hereinafter, a powertrain of an automatic transmission according to a ninth embodiment of the present invention is described in detail with reference to FIG. 9.

As shown in FIG. 9, a powertrain of an automatic transmission according to the ninth embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection a powertrain of an automatic transmission according to the first embodiment of the present invention. Therefore, the compound planetary gear set CPG of the present embodiment forms first, second, third, and fourth operational elements as shown in FIG. 18.

The same as in the first embodiment, the speed reduction device RD of the present embodiment includes a third planetary gear set PG3, a transfer drive gear TFP3, and a transfer driven gear TFG3. An arrangement of the transfer drive gear TFP3 and the transfer driven gear TFG3 is also the same as in the first embodiment.

However, according to the present embodiment in comparison with the first embodiment, the third planetary gear set PG3 is formed as a double pinion planetary gear set including a third sun gear S3, a third planet carrier PC3, and a third ring gear R3. The third sun gear S3 is fixedly connected to the primary input shaft 110, and the third planet carrier PC3 is fixed to the transmission case 190. Therefore, the rotation speed of the primary input shaft 110 inputted through the third sun gear S3 is reduced at the third planetary gear set PG3 and output through the third ring gear R3.

The third ring gear R3 is variably connected to the first sun gear S1 of the first planetary gear set PG1 via the first clutch C1, and is also variably connected to the transfer drive gear TFP3 via the third clutch C3.

Therefore, the same as in the first embodiment, the first operational element N1 rotates at the reduced rotation speed by the operation of the first clutch C1.

In addition, when the third clutch C3 operates, the reduced speed of the third ring gear R3 is delivered to the secondary input shaft 120 through the transfer drive gear TFP3. Therefore, the same as in the first embodiment, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

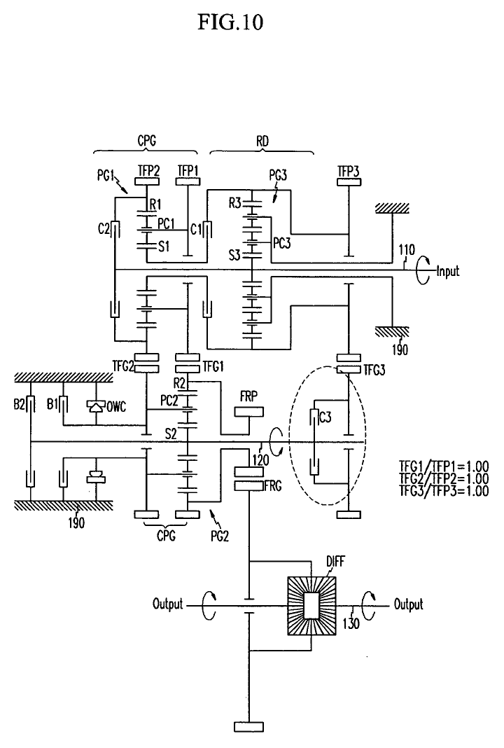

Hereinafter, a powertrain of an automatic transmission according to a tenth embodiment of the present invention is described in detail with reference to FIG. 10.

As shown in FIG. 10, a powertrain of an automatic transmission according to the tenth embodiment of the present invention is similar to a powertrain of an automatic transmission according to the ninth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the ninth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the ninth embodiment.

However, regarding the speed reduction device RD of the present embodiment, connection of the third clutch C3 differs from the ninth embodiment.

That is, regarding the speed reduction device RD of the present embodiment, the transfer drive gear TFP3 is fixedly connected to the third ring gear R3, and the third clutch C3 variably connects the transfer driven gear TFG3 and the secondary input shaft 120.

Therefore, the transfer drive gear TFP3 always rotates at the reduce rotation speed output from the third ring gear R3, and accordingly, the transfer driven gear TFG3 also always rotates at the reduced rotation speed. In this case, the transfer driven gear TFG3 is variably connected to the secondary input shaft 120 via the third clutch C3, and accordingly, the secondary input shaft 120 rotates at the reduced rotation speed by the operation of the third clutch C3. Therefore, according to such arrangement of the third clutch C3, the same as in the ninth embodiment, the fourth operational element N4 rotates at the reduced rotation speed by the operation of the third clutch C3.

Therefore, the same as in the ninth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

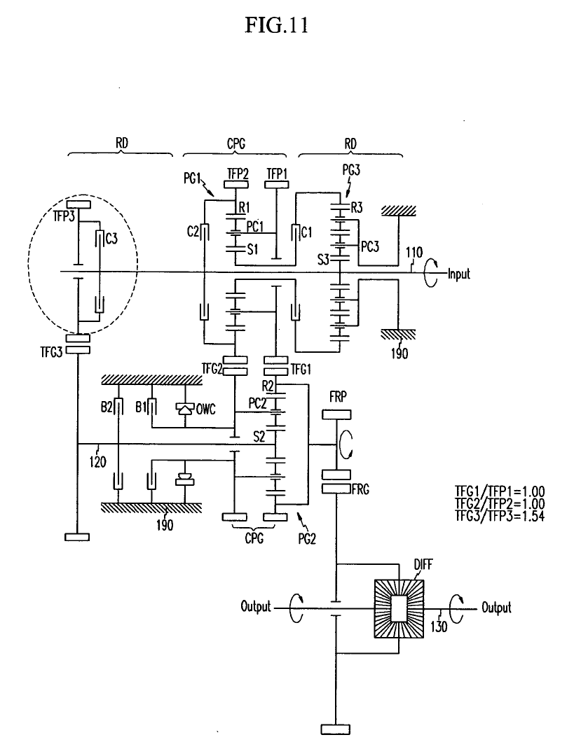

Hereinafter, a powertrain of an automatic transmission according to an eleventh embodiment of the present invention is described in detail with reference to FIG. 11.

As shown in FIG. 11, a powertrain of an automatic transmission according to the eleventh embodiment of the present invention is similar to a powertrain of an automatic transmission according to the ninth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the ninth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the ninth embodiment.

However, regarding the speed reduction device RD of the present embodiment, arrangement of the transfer drive gear TFP3 and the transfer driven gear TFG3 and connection of the third clutch C3 differ from the ninth embodiment.

That is, regarding the speed reduction device RD of the present embodiment, the transfer drive gear TFP3 and the transfer driven gear TFG3 are disposed opposite to the third planetary gear set PG3 with respect to the first planetary gear set PG1.

In the ninth embodiment, the transfer drive gear TFP3 is variably connected to the third ring gear R3 via the third clutch C3. However, according to the present embodiment, the transfer drive gear TFP3 is connected to the primary input shaft 110 via the third clutch C3. In addition, the transfer driven gear TFG3 is fixed to the secondary input shaft 120.

The transfer drive and driven gears TFP3 and TFG3 are formed at a radius ratio corresponding to a predetermined reduction ratio such that reduced speed may be delivered to the secondary input shaft 120 by an operation of the third clutch C3.

For example, the transfer driven gear TFG3 is 1.54 times larger than the transfer drive gear TFP3 in radius, and accordingly, the rotation speed of the primary input shaft 110 is reduced to 1/1.54 times and is delivered to the secondary input shaft 120.

Therefore, the secondary input shaft 120 rotates at the reduced rotation speed by the operation of the third clutch C3. So, according to the present embodiment, the same as in the ninth embodiment, the fourth operational element N4 rotates at the reduced rotation speed by the operation of the third clutch C3.

Therefore, the same as in the ninth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

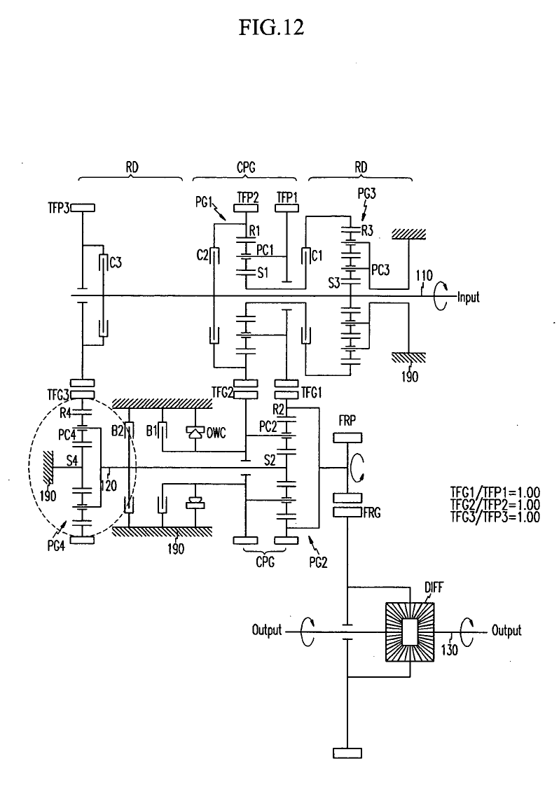

Hereinafter, a powertrain of an automatic transmission according to a twelfth embodiment of the present invention is described in detail with reference to FIG. 12.

As shown in FIG. 12, a powertrain of an automatic transmission according to the twelfth embodiment of the present invention is similar to a powertrain of an automatic transmission according to the eleventh embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the eleventh embodiment (equivalently, the ninth embodiment) of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the eleventh embodiment (equivalently, the ninth embodiment). In addition, the third clutch C3 variably connects the primary input shaft 110 and the transfer drive gear TFP3, the same as in the eleventh embodiment.

However, regarding the speed reduction device RD of the present embodiment, details of the transfer drive gear TFP3 and the transfer driven gear TFG3 differ from the eleventh embodiment.

In more detail, the speed reduction device RD of the present embodiment further includes a fourth planetary gear set PG4 arranged on the secondary input shaft 120 and externally gear-meshed with the transfer drive gear TFP3.

Such a fourth planetary gear set PG4 is formed as a single pinion planetary gear set including a fourth sun gear S4, a fourth planet carrier PC4, and a fourth ring gear R4. The fourth sun gear S4 is fixedly connected to the transmission case 190. The fourth planet carrier PC4 is fixedly connected to the secondary input shaft 120. The fourth ring gear R4 is formed with the transfer driven gear TFG3 on its exterior circumference, and is externally gear-meshed with the transfer drive gear TFP3 through the transfer driven gear TFG3.

In addition, the transfer drive and driven gears TFP3 and TFG3 have equal radii, which is different from the eleventh embodiment.

Therefore, when the third clutch C3 operates, the rotation speed of the primary input shaft 110 is delivered to the transfer driven gear TFG3 (i.e., the fourth ring gear R4) without any change through the transfer drive gear TFP3. In addition, the fourth planetary gear set PG4 reduces the rotation speed of the fourth ring gear R4 and outputs the reduced speed to the secondary input shaft 120 through the fourth planet carrier PC4.

Therefore, the secondary input shaft 120 rotates at the reduced rotation speed by the operation of the third clutch C3. Therefore, according to the present embodiment also, the same as in the ninth embodiment, the fourth operational element N4 rotates at the reduced rotation speed by the operation of the third clutch C3.

Therefore, the same as in the ninth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

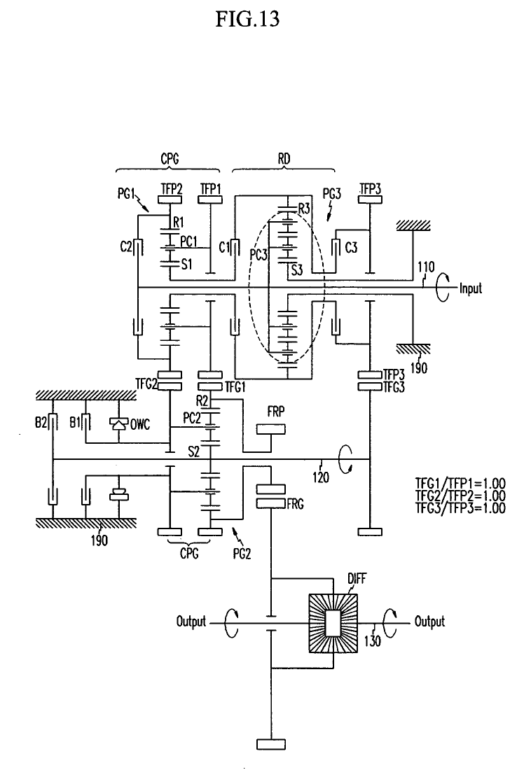

Hereinafter, a powertrain of an automatic transmission according to a thirteenth embodiment of the present invention is described in detail with reference to FIG. 13.

As shown in FIG. 13, a powertrain of an automatic transmission according to the thirteenth embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

The same as in the first embodiment, the speed reduction device RD of the present embodiment includes a third planetary gear set PG3, a transfer drive gear TFP3, and a transfer driven gear TFG3. An arrangement of the transfer drive gear TFP3 and the transfer driven gear TFG3 is also the same as in the first embodiment.

However, according to the present embodiment in comparison with the first embodiment, the third planetary gear set PG3 is formed as a double pinion planetary gear set including a third sun gear S3, a third planet carrier PC3, and a third ring gear R3. The third planet carrier PC3 is fixedly connected to the primary input shaft 110, and the third sun gear S3 is fixed to the transmission case 190. Therefore, the rotation speed of the primary input shaft 110 received through the third planet carrier PC3 is reduced at the third planetary gear set PG3 and output through the third ring gear R3.

The third ring gear R3 is variably connected to the first sun gear S1 of the first planetary gear set PG1 via the first clutch C1, and is also variably connected to the transfer drive gear TFP3 via the third clutch C3.

Therefore, the same as in the first embodiment, the first operational element N1 rotates at the reduced rotation speed by the operation of the first clutch C1.

In addition, when the third clutch C3 operates, the reduced speed of the third ring gear R3 is transmitted to the secondary input shaft 120 through transfer drive gear TFP3. Therefore, the same as in the first embodiment, the fourth operational element N4 rotates at the reduced rotation speed by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

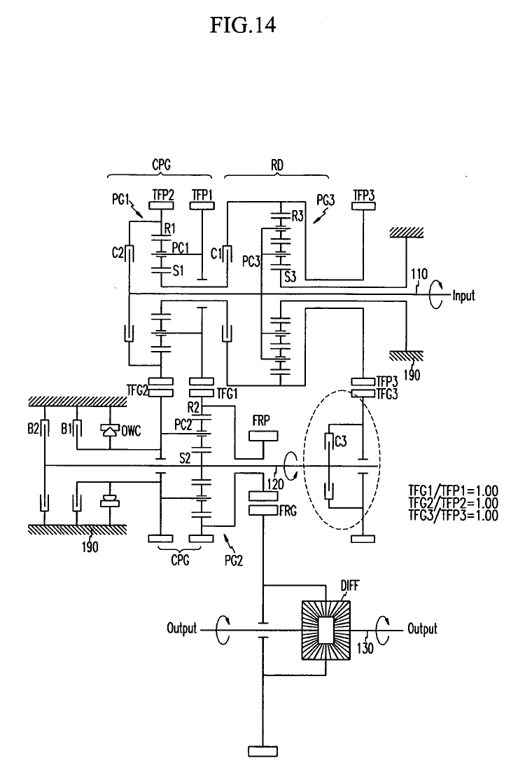

Hereinafter, a powertrain of an automatic transmission according to a fourteenth embodiment of the present invention is described in detail with reference to FIG. 14.

As shown in FIG. 14, a powertrain of an automatic transmission according to the fourteenth embodiment of the present invention is similar to a powertrain of an automatic transmission according to the thirteenth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the thirteenth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the thirteenth embodiment.

However, regarding the speed reduction device RD of the present embodiment, connection of the third clutch C3 differs from the thirteenth embodiment.

That is, regarding the speed reduction device RD of the present embodiment, the transfer drive gear TFP3 is fixedly connected to the third ring gear R3, and the third clutch C3 variably connects the transfer driven gear TFG3 and the secondary input shaft 120.

Therefore, the transfer drive gear TFP3 always rotates at the reduce rotation speed output from the third ring gear R3, and accordingly, the transfer driven gear TFG3 also always rotates at the reduced rotation speed. In this case, the transfer driven gear TFG3 is variably connected to the secondary input shaft 120 via the third clutch C3, and accordingly, the secondary input shaft 120 rotates at the reduced rotation speed by the operation of the third clutch C3. Therefore, according to such arrangement of the third clutch C3, the same as in the thirteenth embodiment, the fourth operational element N4 rotates at the reduced rotation speed by the operation of the third clutch C3.

Therefore, the same as in the thirteenth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

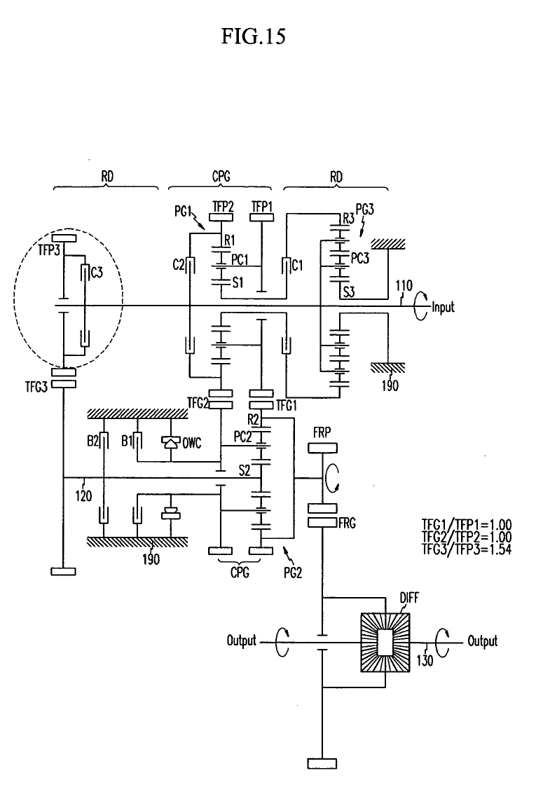

Hereinafter, a powertrain of an automatic transmission according to a fifteenth embodiment of the present invention is described in detail with reference to FIG. 15.

As shown in FIG. 15, a powertrain of an automatic transmission according to the fifteenth embodiment of the present invention is similar to a powertrain of an automatic transmission according to the thirteenth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the thirteenth embodiment of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the thirteenth embodiment.

However, regarding the speed reduction device RD of the present embodiment, arrangement of the transfer drive gear TFP3 and the transfer driven gear TFG3 and connection of the third clutch C3 differ from the thirteenth embodiment.

That is, regarding the speed reduction device RD of the present embodiment, the transfer drive gear TFP3 and the transfer driven gear TFG3 are disposed opposite to the third planetary gear set PG3 with respect to the first planetary gear set PG1.

In the thirteenth embodiment, the transfer drive gear TFP3 is variably connected to the third ring gear R3 via the third clutch C3. However, according to the present embodiment, the transfer drive gear TFP3 is connected to the primary input shaft 110 via the third clutch C3. In addition, the transfer driven gear TFG3 is fixed to the secondary input shaft 120.

The transfer drive and driven gears TFP3 and TFG3 are formed at a radius ratio corresponding to a predetermined reduction ratio such that reduced speed may be delivered to the secondary input shaft 120 by an operation of the third clutch C3.

For example, the transfer driven gear TFG3 is 1.54 times larger than the transfer drive gear TFP3 in radius, and accordingly, the rotation speed of the primary input shaft 110 is reduced to 1/1.54 times and is delivered to the secondary input shaft 120.

Therefore, the secondary input shaft 120 rotates at the reduced rotation speed by the operation of the third clutch C3. So, according to the present embodiment, the same as in the thirteenth embodiment, the fourth operational element N4 rotates at the reduced rotation speed by the operation of the third clutch C3.

Therefore, the same as in the thirteenth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

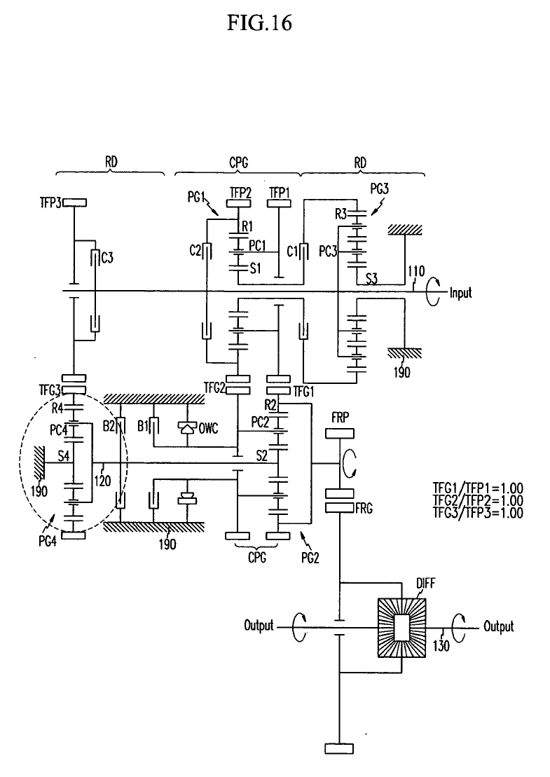

Hereinafter, a powertrain of an automatic transmission according to a sixteenth embodiment of the present invention is described in detail with reference to FIG. 16.

As shown in FIG. 16, a powertrain of an automatic transmission according to the sixteenth embodiment of the present invention is similar to a powertrain of an automatic transmission according to the fifteenth embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the fifteenth embodiment (equivalently, the thirteenth embodiment) of the present invention. Therefore, the compound planetary gear set CPG of the present embodiment forms first, second, third, and fourth operational elements as shown in FIG. 18.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the fifteenth embodiment (equivalently, the thirteenth embodiment). In addition, the third clutch C3 variably connects the primary input shaft 110 and the transfer drive gear TFP3, the same as in the fifteenth embodiment.

However, regarding the speed reduction device RD of the present embodiment, details of the transfer drive gear TFP3 and the transfer driven gear TFG3 differ from the fifteenth embodiment.

In more detail, the speed reduction device RD of the present embodiment further includes a fourth planetary gear set PG4 arranged on the secondary input shaft 120 and externally gear-meshed with the transfer drive gear TFP3.

Such a fourth planetary gear set PG4 is formed as a single pinion planetary gear set including a fourth sun gear S4, a fourth planet carrier PC4, and a fourth ring gear R4. The fourth sun gear S4 is fixedly connected to the transmission case 190. The fourth planet carrier PC4 is fixedly connected to the secondary input shaft 120. The fourth ring gear R4 is formed with the transfer driven gear TFG3 on its exterior circumference, and is externally gear-meshed with the transfer drive gear TFP3 through the transfer driven gear TFG3.

In addition, the transfer drive and driven gears TFP3 and TFG3 have equal radii, which is different from the fifteenth embodiment.

Therefore, when the third clutch C3 operates, the rotation speed of the primary input shaft 110 is delivered to the transfer driven gear TFG3 (i.e., the fourth ring gear R4) without any change through the transfer drive gear TFP3. In addition, the fourth planetary gear set PG4 reduces the rotation speed of the fourth ring gear R4 and outputs the reduced speed to the secondary input shaft 120 through the fourth planet carrier PC4.

Therefore, the secondary input shaft 120 rotates at the reduced rotation speed by the operation of the third clutch C3. So, according to the present embodiment, the same as in the thirteenth embodiment, the fourth operational element N4 rotates at the reduced rotation speed by the operation of the third clutch C3.

Therefore, the same as in the thirteenth embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

In the above-described sixteen (16) embodiments, various exemplary variations are described in connection with a powertrain of an automatic transmission realizing six forward speeds and one reverse speed by a compound planetary gear set CPG, a speed reduction device RD for delivering a reduced speed to the compound planetary gear set CPG, three clutches, and two brakes, wherein the compound planetary gearset CPG includes first and second planetary gear sets PG1 and PG2 respectively arranged on primary and secondary input shafts 110 and 120.

A powertrain of an automatic transmission realizing seven forward speeds and one reverse speed may be achieved by addition of simple additional elements to such exemplary variations.

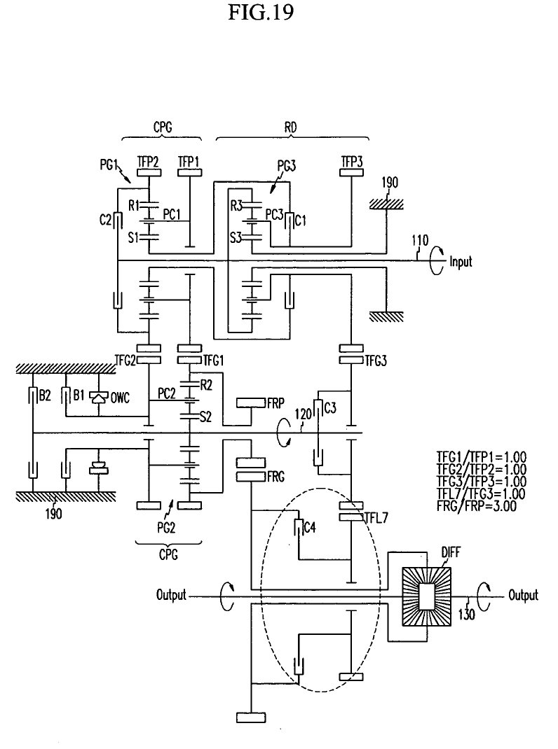

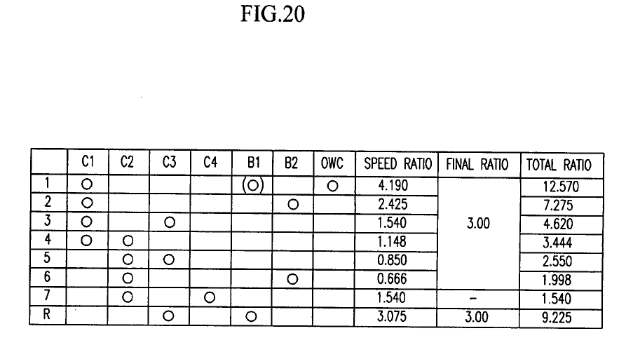

Hereinafter, as an example of such a powertrain, a powertrain of an automatic transmission according to a seventeenth embodiment of the present invention is described in detail with reference to FIG. 19 and FIG. 20.

A powertrain of the seventeenth embodiment is a powertrain of an automatic transmission realizing seven forward speeds and one reverse speed by an addition of additional elements, based on a powertrain of an automatic transmission according to the second embodiment. However, it is notable that the spirit of the invention realizing the seventh forward speed by the additional element described hereinafter may also be applied to the second, sixth, tenth, and fourteenth embodiments. That is, the spirit of the present embodiment may be applied to the case that the third clutch C3 variably connects the secondary input shaft 120 and the transfer driven gear TFG3.

Firstly, in the powertrains of such embodiments, the final drive gear FRP and the transfer driven gear TFG3 rotate around the secondary input shaft 120. The final drive gear FRP is externally gear-meshed with the final driven gear FRG fixedly connected to the differential DIFF, and accordingly, it may drive the differential DIFF.

According to the present embodiment, a first output mediating gear TFL7 is rotatably disposed on an output shaft 130, being externally gear-meshed with the transfer driven gear TFG3. In addition, the final driven gear FRG and the first output mediating gear TFL7 is variably interconnected by a fourth clutch C4. At the seventh forward speed, the first output mediating gear TFL7 delivers, instead of an output of the final drive gear FRP, an output of the transfer driven gear TFG3 to the final driven gear FRG.

An operational chart for operating such a powertrain of an automatic transmission according to the present embodiment is shown in FIG. 20.

At the first to sixth forward speeds and the reverse speed, a powertrain of an automatic transmission according to the present embodiment is operated according to the same operational chart for the first embodiment to the sixteenth embodiment. In addition thereto, the fourth clutch C4 operates at the seventh forward speed, as shown in FIG. 20.

FIG. 20 illustrates that the second clutch C2 operates at the seventh forward speed. However, it should be noted that the operation of the second clutch C2 is not necessary for achieving the seventh forward speed, and it merely remains operating for a convenience of shift control of shifting between sixth and seventh forward speeds and skip-shifting between the fifth and seventh forward speeds.

Hereinafter, achievement of the seventh forward speed by operating a powertrain of an automatic transmission of the present embodiment according to the operational chart of FIG. 20 is described in detail.

At the first to sixth forward speeds of the second, sixth, tenth, and fourteenth embodiments, and the present embodiment, the rotation speed of the primary input shaft 110 is reduced by a reduction ratio of each shift speed and output through the final drive gear FRP, and the rotation speed of the final drive gear FRP is delivered to the differential DIFF after being reduced by a final reduction ratio relating to radius ratio of the final drive gear FRP and the final driven gear FRG.

Therefore, a total reduction ratio of respective shift speed is obtained by multiplying the reduction ratio of the respective shift speed by the final reduction ratio.

Exemplary total reduction ratios calculated as such are shown in FIG. 20, in connection with the case that the final reduction ratio is 3.0.

At the seventh forward speed, the rotation speed of the primary input shaft 110 is reduced at the third planetary gear set PG3 and is delivered to the transfer driven gear TFG3 through the transfer drive gear TFP3. Then, the rotation speed of the transfer driven gear TFG3 is directly delivered to the first output mediating gear TFL7. At such a seventh forward speed, the final driven gear FRG rotates at the same speed with the first output mediating gear TFL7 since the fourth clutch C4 operates.

Therefore, the final reduction ratio is not applied at the seventh forward speed. Accordingly, the rotation speed of the primary input shaft 110 is reduced merely by the reduction ratio of the third planetary gear set PG3 and is delivered to the differential DIFF.

Therefore, as shown in FIG. 20, the total reduction ratio of the seventh forward speed is formed smaller than the total reduction ratios of the first to sixth forward speeds which are applied with the final reduction ratio.

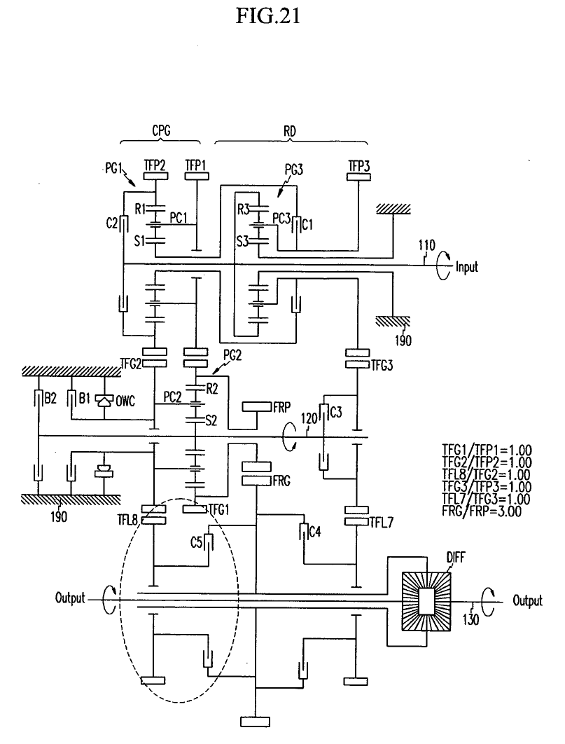

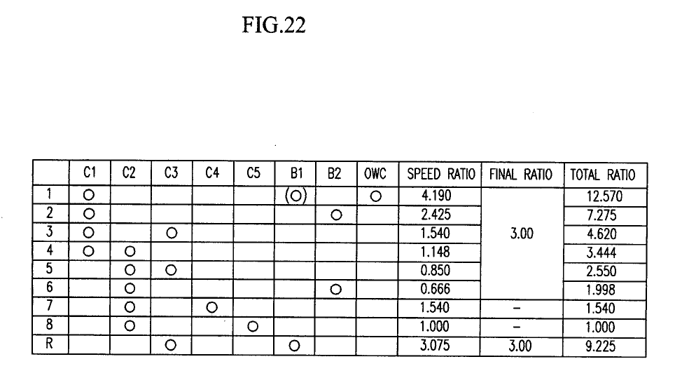

Hereinafter, a powertrain of an automatic transmission according to an eighteenth embodiment of the present invention is described in detail with reference to FIG. 21 and FIG. 22.

A powertrain of an automatic transmission according to the eighteenth embodiment of the present invention is a powertrain of an automatic transmission realizing eight forward speeds and one reverse speed by an addition of additional elements based on a powertrain of an automatic transmission according to the seventeenth embodiment.

According to a powertrain of an automatic transmission through the first to sixteenth embodiments, the first ring gear R1 is variably connected to the primary input shaft 110 via the second clutch C2. The first ring gear R1 is externally gear-meshed with the second planet carrier PC2.

According to the present embodiment, a second output mediating gear TFL8 is rotatably disposed on an output shaft 130, being externally gear-meshed with the second planet carrier PC2. In addition, the final driven gear FRG and the second output mediating gear TFL8 are variably interconnected by a fifth clutch C5. At the eighth forward speed, the second output mediating gear TFL8 delivers, instead of an output of the final drive gear FRP, an output of the second planet carrier PC2 to the final driven gear FRG.

An operational chart for operating such a powertrain of an automatic transmission according to the present embodiment is shown in FIG. 22.

At the first to seventh forward speeds and the reverse speed, a powertrain of an automatic transmission according to the present embodiment is operated according to the same operational chart for a powertrain of the seventeenth embodiment. In addition thereto, the second clutch C2 and the fifth clutch C5 operate at the eighth forward speed, as shown in FIG. 22.

At the eighth forward speed, rotation speed of the primary input shaft 110 is delivered to the first ring gear R1 without any change since the second clutch C2 operates, and the speed of the first ring gear R1 is delivered to the second output mediating gear TFL8 through the second planet carrier PC2 without any change.

Therefore, the second output mediating gear TFL8 rotates at the same speed with the primary input shaft 110. In this case, the final driven gear FRG also rotates at the speed of the primary input shaft 110 by the operation of the fifth clutch C5, and accordingly, the rotation speed of the primary input shaft 110 is delivered to the differential DIFF without any change. Therefore, the total reduction ratio of such an eighth forward speed equals 1.0 which is lower than the reduction ratio of the seventh forward speed, and accordingly, the eighth forward speed is achieved.

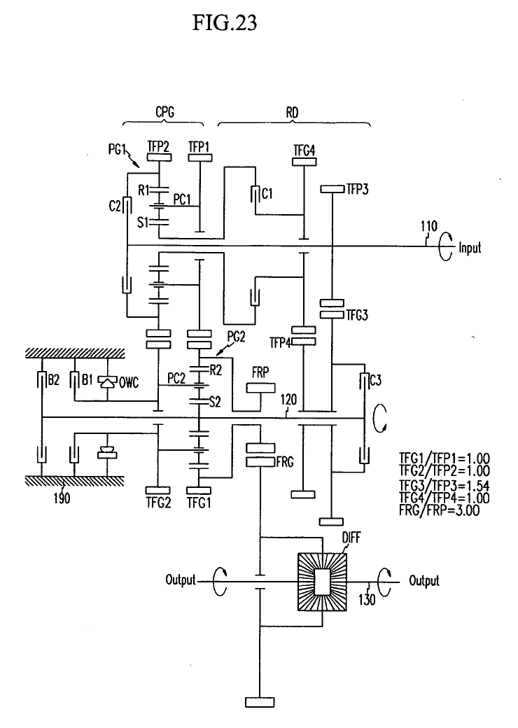

Hereinafter, a powertrain of an automatic transmission according to the nineteenth embodiment of the present invention is described in detail with reference to FIG. 23.

As shown in FIG. 23, a powertrain of an automatic transmission according to the nineteenth embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

However, regarding a powertrain of an automatic transmission according to the present embodiment, structure of the speed reduction device RD is different from the first embodiment.

As shown in FIG. 23, a speed reduction device RD of the present embodiment includes a transfer drive gear TFP3 disposed on the primary input shaft 110, a transfer driven gear TFG3 disposed on the secondary input shaft 120 and externally gear-meshed with the transfer drive gear TFP3, a mediating drive gear TFP4 disposed on the secondary input shaft 120 and fixedly connected to the transfer driven gear TFG3, and a mediating driven gear TFG4 disposed on the primary input shaft 110 and externally gear-meshed with the mediating drive gear TFP4.

The first clutch C1 of the present embodiment variably interconnects the mediating driven gear TFG4 and the first operational element N1. In addition, the third clutch C3 variably interconnects the transfer driven gear TFG3 and the secondary input shaft 120.

The transfer drive and driven gears TFP3 and TFG3 are formed at a radius ratio corresponding to a predetermined reduction ratio. That is, for example, the transfer driven gear TFG3 is 1.54 times larger than the transfer drive gear TFP3 in radius. Therefore, when the third clutch C3 operates, the rotation speed of the primary input shaft 110 is reduced by 1/1.54 and is then delivered to the secondary input shaft 120.

In addition the reduced speed received at the transfer driven gear TFG3 is delivered to the mediating driven gear TFG4 through the mediating drive gear TFP4. Therefore, when the first clutch C1 operates, the reduced speed of the mediating driven gear TFG4 is supplied to the first sun gear S1.

That is, although details of the speed reduction device RD are different from the first embodiment, the present embodiment is the same as in the first embodiment in that the reduced speed is supplied to the first operational element N1 by the operation of the first clutch C1 and to the fourth operational element N4 by the operation of the third clutch C3.

Therefore, the same as in the first embodiment, a powertrain of an automatic transmission according to the present embodiment is operated according to the operational chart shown in FIG. 17. Resultantly, six forward speeds and one reverse speed are realized according to speed lines of the shift diagram shown in FIG. 18.

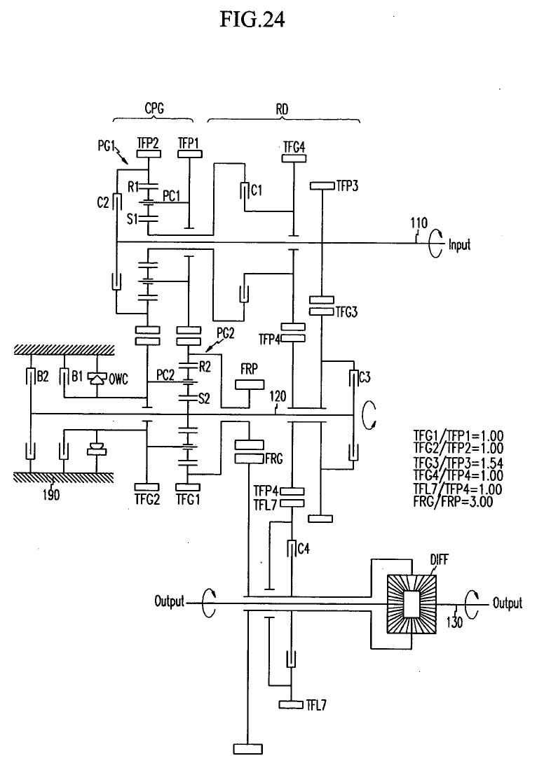

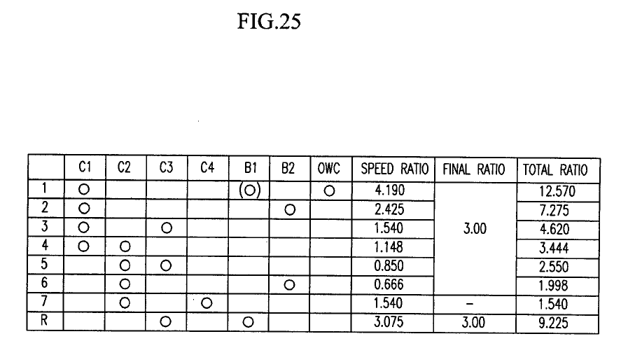

Hereinafter, a powertrain of an automatic transmission according to a twentieth embodiment of the present invention is described in detail with reference to FIG. 24 and FIG. 25.

A powertrain of the twentieth embodiment of the present invention is a powertrain of an automatic transmission realizing seven forward speeds and one reverse speed by an addition of additional elements based on a powertrain of an automatic transmission according to the nineteenth embodiment.

In a powertrain according to the nineteenth embodiment, the final drive gear FRP and the transfer driven gear TFG3 rotates around the secondary input shaft 120. The final drive gear FRP is externally gear-meshed with the final driven gear FRG that is fixedly connected to the differential DIFF such that it may drive the differential DIFF.

According to the present embodiment, a first output mediating gear TFL7 is rotatably disposed on an output shaft 130, being externally gear-meshed with the mediating drive gear TFP4. In addition, the final driven gear FRG and the first output mediating gear TFL7 is variably interconnected by a fourth clutch C4. At the seventh forward speed, the first output mediating gear TFL7 delivers, instead of an output of the final drive gear FRP, an output of the mediating drive gear TFP4 to the final driven gear FRG.

An operational chart for operating such a powertrain of an automatic transmission according to the present embodiment is shown in FIG. 25.

At the first to sixth forward speeds and the reverse speed, a powertrain of an automatic transmission according to the present embodiment is operated according to the same operational chart for a powertrain of the nineteenth embodiment, that is, the operational chart shown in FIG. 17. In addition thereto, as shown in FIG. 25, the fourth clutch C4 operates at the seventh forward speed.

FIG. 25 illustrates that the second clutch C2 operates at the seventh forward speed. However, it should be noted that the operation of the second clutch C2 is not necessary for achieving the seventh forward speed, and it merely remains operating for a convenience of shift control of shifting between sixth and seventh forward speeds and skip-shifting between the fifth and seventh forward speeds.

Hereinafter, achievement of the seventh forward speed by operating a powertrain of an automatic transmission of the present embodiment according to the operational chart shown in FIG. 25 is described in detail. The manners of achieving the seventh forward speed in a powertrain of an automatic transmission according to the present embodiment are similar to those that have been described in connection with the seventeenth embodiment.

At the first to sixth forward speeds, the rotation speed of the primary input shaft 110 is reduced by a reduction ratio of each shift speed and output through the final drive gear FRP, and the rotation speed of the final drive gear FRP is delivered to the differential DIFF after being reduced by a final reduction ratio relating to radius ratio of the final drive gear FRP and the final driven gear FRG.

Therefore, a total reduction ratio of respective shift speed is obtained by multiplying the reduction ratio of the respective shift speed by the final reduction ratio.

At the seventh forward speed, the rotation speed of the primary input shaft 110 is reduced between the transfer drive gear TFP3 and the transfer driven gear TFG3, and is directly delivered to the first output mediating gear TFL7 through the mediating drive gear TFP4. At such a seventh forward speed, the final driven gear FRG rotates at the same speed as the first output mediating gear TFL7 since the fourth clutch C4 operates.

Therefore, the final reduction ratio is not applied at the seventh forward speed. Accordingly, the rotation speed of the primary input shaft 110 is reduced merely by the reduction ratio between the transfer drive gear TFP3 and the transfer driven gear TFG3 and is delivered to the differential DIFF.

Therefore, the same as in the seventeenth embodiment, the total reduction ratio of the seventh forward speed is formed smaller than the total reduction ratios of the first to sixth forward speeds which are applied with the final reduction ratio.

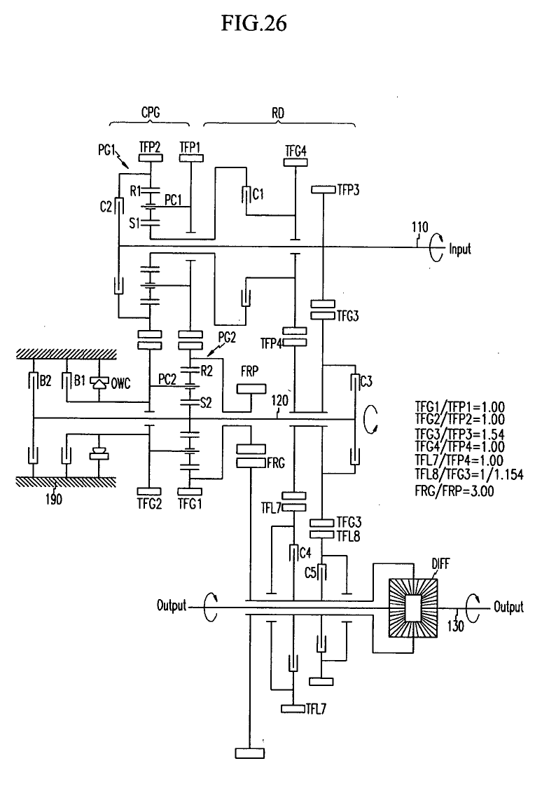

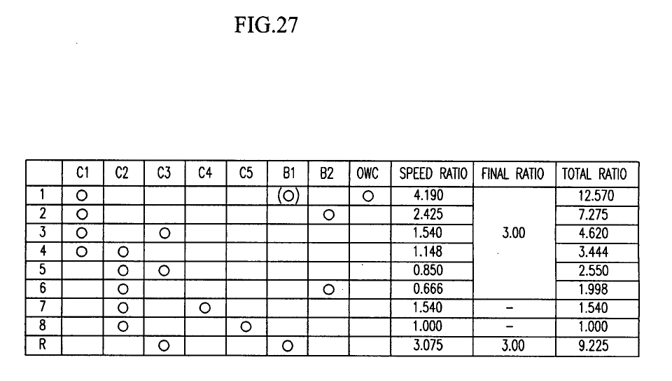

Hereinafter, a powertrain of an automatic transmission according to a twenty-first embodiment of the present invention is described in detail with reference to FIG. 26 and FIG. 27.

A powertrain of an automatic transmission according to the twenty-first embodiment of the present invention is a powertrain of an automatic transmission realizing eight forward speeds and one reverse speed by an addition of additional elements based on a powertrain of an automatic transmission according to the twentieth embodiment.

According to the present embodiment, in addition to the twentieth embodiment a second output mediating gear TFL8 is rotatably disposed on an output shaft 130, being externally gear-meshed with the transfer driven gear TFG3.

In addition, the final driven gear FRG and the second output mediating gear TFL8 are variably interconnected by a fifth clutch C5.

The transfer driven gear TFG3 and the second output mediating gear TFL8 are formed at a radius ratio corresponding to a predetermined ratio for speed increase. That is, for example, the second output mediating gear TFL8 is 1.54 times smaller than transfer driven gear TFG3 in radius.

Therefore, the rotation speed that is reduced while being transmitted from the transfer drive gear TFP3 to the transfer driven gear TFG3 is increased while being transmitted from the transfer driven gear TFG3 to the second output mediating gear TFL8. Therefore, the second output mediating gear TFL8 rotates faster than the first output mediating gear TFL7.

An operational chart for operating such a powertrain of an automatic transmission according to the present embodiment is shown in FIG. 27.

At the first to seventh forward speeds and the reverse speed, a powertrain of an automatic transmission according to the present embodiment is operated according to the same operational chart for a powertrain of the twentieth embodiment. In addition thereto, the fifth clutch C5 operates at the eighth forward speed, as shown in FIG. 27.

FIG. 27 illustrates that the second clutch C2 operates at the eighth forward speed. However, it should be noted that the operation of the second clutch C2 is not necessary for achieving the eighth forward speed, and it merely remains operating for a convenience of shift control and skip-shift control.

Hereinafter, achievement of the eighth forward speed by operating a powertrain of an automatic transmission of the present embodiment according to the operational chart shown in FIG. 27 is described in detail.

The same as in the seventh forward speed, the transfer driven gear TFG3 rotates at the reduced rotation speed at the eighth forward speed. However, the reduced rotation speed of the transfer driven gear TFG3 is increased while being transmitted to the second output mediating gear TFL8. That is, the second output mediating gear TFL8 rotates faster than the first output mediating gear TFL7.

Therefore, when the rotation of the second output mediating gear TFL8 is delivered to the differential DIFF by the operation of the fifth clutch C5, the differential DIFF rotates faster than the first output mediating gear TFL7, and accordingly, the eighth forward speed is realized.

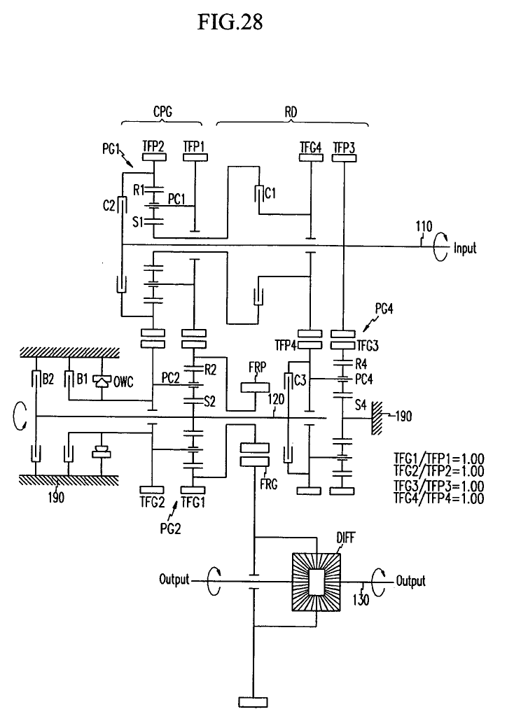

Hereinafter, a powertrain of an automatic transmission according to a twenty-second embodiment of the present invention is described in detail with reference to FIG. 28.

As shown in FIG. 28, a powertrain of an automatic transmission according to the twenty-second embodiment of the present invention is similar to a powertrain of an automatic transmission according to the nineteenth embodiment of the present invention (refer to FIG. 23).

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the compound planetary gear set CPG are the same as have been described in connection with a powertrain of an automatic transmission according to the first embodiment of the present invention. Therefore, the compound planetary gear set CPG of the present embodiment forms first, second, third, and fourth operational elements as shown in FIG. 18.

In addition, the same as in the nineteenth embodiment, a speed reduction device RD of the present embodiment includes a transfer drive gear TFP3 disposed on the primary input shaft 110, a transfer driven gear TFG3 disposed on the secondary input shaft 120 and externally gear-meshed with the transfer drive gear TFP3, a mediating drive gear TFP4 disposed on the secondary input shaft 120, and a mediating driven gear TFG4 disposed on the primary input shaft 110 and externally gear-meshed with the mediating drive gear TFP4.

The first clutch C1 of the present embodiment variably interconnects the mediating driven gear TFG4 and the first operational element N1. In addition, the third clutch C3 variably interconnects the mediating drive gear TFP4 and the secondary input shaft 120.

In a powertrain of an automatic transmission according to the nineteenth embodiment, a reduction ratio is formed by the radius ratio of the transfer drive gear TFP3 and the transfer driven gear TFG3. However, in a powertrain of an automatic transmission according to the present embodiment, a fourth planetary gear set PG4 is included for speed reduction.

That is, the present embodiment is different from the nineteenth embodiment at least in that the fourth planetary gear set PG4 is further included. The fourth planetary gear set PG4 includes a fourth sun gear S4, a fourth planet carrier PC4, and a fourth ring gear R4. The fourth sun gear S4 is fixed to the transmission case 190. The transfer driven gear TFG3 is formed on an exterior circumference of the fourth ring gear R4. The mediating drive gear TFP4 is formed at the fourth planet carrier PC4.

Therefore, when the third clutch C3 operates, the rotation speed of the primary input shaft 110 is reduced by 1/1.54 and is then delivered to the secondary input shaft 120.

In addition, the reduced speed of the mediating drive gear TFP4 is delivered to the mediating driven gear TFG4. Therefore, when the first clutch C1 operates, the reduced speed of the mediating driven gear TFG4 is supplied to the first sun gear S1.

That is, although details of the speed reduction device RD are different from the nineteenth embodiment, the present embodiment is the same as in the nineteenth embodiment in that the reduced speed is supplied to the first operational element N1 by the operation of the first clutch C1 and to the fourth operational element N4 by the operation of the third clutch C3.

Therefore, the same as in the first and nineteenth embodiments, a powertrain of an automatic transmission according to the present embodiment is operated according to the operational chart shown in FIG. 17. Resultantly, six forward speeds and one reverse speed are realized according to speed lines of the shift diagram shown in FIG. 18.

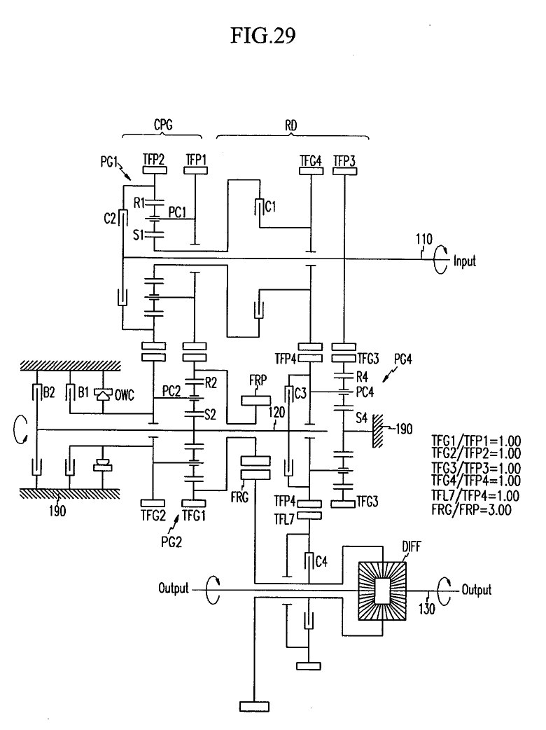

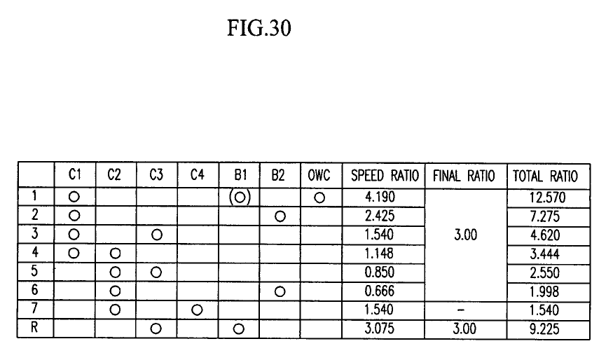

Hereinafter, a powertrain of an automatic transmission according to a twenty-third embodiment of the present invention is described in detail with reference to FIG. 29 and FIG. 30.

A powertrain of an automatic transmission according to the twenty-third embodiment of the present invention is a powertrain of an automatic transmission realizing seven forward speeds and one reverse speed by an addition of additional elements based on a powertrain of an automatic transmission according to the twenty-second embodiment.

In a powertrain according to the twenty-second embodiment, the final drive gear FRP and the transfer driven gear TFG3 rotate around the secondary input shaft 120. The final drive gear FRP is externally gear-meshed with the final driven gear FRG that is fixedly connected to the differential DIFF such that it may drive the differential DIFF.

According to the present embodiment, a first output mediating gear TFL7 is rotatably disposed on an output shaft 130, being externally gear-meshed with the mediating drive gear TFP4. In addition, the final driven gear FRG and the first output mediating gear TFL7 is variably interconnected by a fourth clutch C4. At the seventh forward speed, the first output mediating gear TFL7 delivers, instead of an output of the final drive gear FRP, an output of the mediating drive gear TFP4 to the final driven gear FRG.

An operational chart for operating such a powertrain of an automatic transmission according to the present embodiment is shown in FIG. 30.

At the first to sixth forward speeds and the reverse speed, a powertrain of an automatic transmission according to the present embodiment is operated according to the same operational chart for a powertrain of the twenty-second embodiment, that is, the operational chart shown in FIG. 17. In addition thereto, as shown in FIG. 30, the fourth clutch C4 operates at the seventh forward speed.

FIG. 30 illustrates that the second clutch C2 operates at the seventh forward speed. However, it should be noted that the operation of the second clutch C2 is not necessary for achieving the seventh forward speed, and it merely remains operating for a convenience of shift control of shifting between sixth and seventh forward speeds and skip-shifting between the fifth and seventh forward speeds.

Hereinafter, achievement of the seventh forward speed by operating a powertrain of an automatic transmission of the present embodiment according to the operational chart shown in FIG. 30 is described in detail. The manners of achieving the seventh forward speed in a powertrain of an automatic transmission according to the present embodiment are similar those that have been described in connection with the twentieth embodiment.

At the first to sixth forward speeds, the rotation speed of the primary input shaft 110 is reduced by a reduction ratio of each shift speed and output through the final drive gear FRP, and the rotation speed of the final drive gear FRP is delivered to the differential DIFF after being reduced by a final reduction ratio relating to radius ratio of the final drive gear FRP and the final driven gear FRG.

Therefore, a total reduction ratio of respective shift speed is obtained by multiplying the reduction ratio of the respective shift speed by the final reduction ratio.

At the seventh forward speed, the reduced speed of the fourth planetary gear set PG4 is directly delivered to the first output mediating gear TFL7 through the mediating drive gear TFP4. At such a seventh forward speed, the final driven gear FRG rotates at the same speed with the first output mediating gear TFL7 since the fourth clutch C4 operates.

Therefore, the final reduction ratio is not applied at the seventh forward speed. Accordingly, the rotation speed of the primary input shaft 110 is reduced merely by the reduction ratio of the fourth planetary gear set PG4 and is delivered to the differential DIFF.

Therefore, the same as in the twentieth embodiment, the total reduction ratio of the seventh forward speed is formed smaller than the total reduction ratios of the first to sixth forward speeds which are applied with the final reduction ratio.

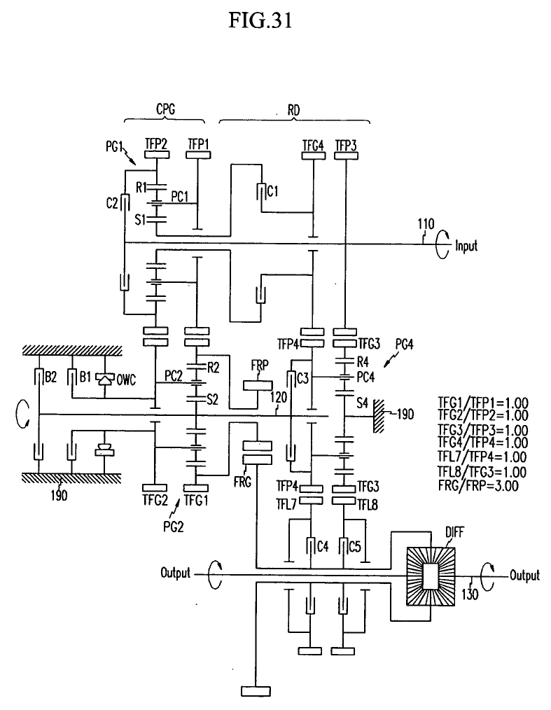

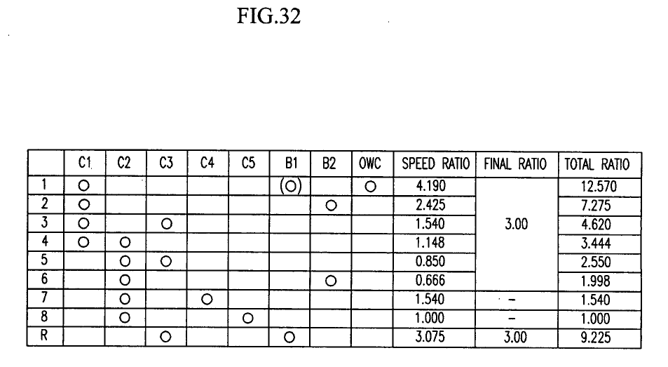

Hereinafter, a powertrain of an automatic transmission according to a twenty-fourth embodiment of the present invention is described in detail with reference to FIG. 31 and FIG. 32.

A powertrain of an automatic transmission according to the twenty-fourth embodiment of the present invention is a powertrain of an automatic transmission realizing eight forward speeds and one reverse speed by an addition of additional element based on a powertrain of an automatic transmission according to the twenty-third embodiment.

According to the present embodiment, in addition to the twenty-third embodiment, a second output mediating gear TFL8 is rotatably disposed on an output shaft 130, being externally gear-meshed with the transfer driven gear TFG3. In addition, the final driven gear FRG and the second output mediating gear TFL8 are variably interconnected by a fifth clutch C5. At the eighth forward speed, the second output mediating gear TFL8 delivers, instead of an output of the final drive gear FRP, an output of the transfer driven gear TFG3 to the final driven gear FRG.

The transfer driven gear TFG3 and the second output mediating gear TFL8 have equal radii. Therefore, the rotation speed of the primary input shaft 110 is unchanged while being delivered to the second output mediating gear TFL8 through the transfer drive gear TFP3 and the transfer driven gear TFG3. Therefore, the second output mediating gear TFL8 rotates faster than the first output mediating gear TFL7.

An operational chart for operating such a powertrain of an automatic transmission according to the present embodiment is shown in FIG. 32.

At the first to seventh forward speeds and the reverse speed, a powertrain of an automatic transmission according to the present embodiment is operated according to the same operational chart for a powertrain of the twenty-third embodiment. In addition thereto, the fifth clutch C5 operates at the eighth forward speed, as shown in FIG. 32.

FIG. 32 illustrates that the second clutch C2 operates at the eighth forward speed. However, it should be noted that the operation of the second clutch C2 is not necessary for achieving the eighth forward speed, and it merely remains operating for a convenience of shift control and skip-shift control.

Hereinafter, achievement of the eighth forward speed by operating a powertrain of an automatic transmission of the present embodiment according to the operational chart shown in FIG. 32 is described in detail.

The first output mediating gear TFL7 rotates at a speed reduced at the fourth planetary gear set PG4, and the second output mediating gear TFL8 rotates at the same speed as the primary input shaft 110. Therefore, the second output mediating gear TFL8 rotates faster than the first output mediating gear TFL7.

Therefore, when the rotation of the second output mediating gear TFL8 is delivered to the differential DIFF by the operation of the fifth clutch C5, the differential DIFF rotates faster than the first output mediating gear TFL7, and accordingly, the eighth forward speed is realized.

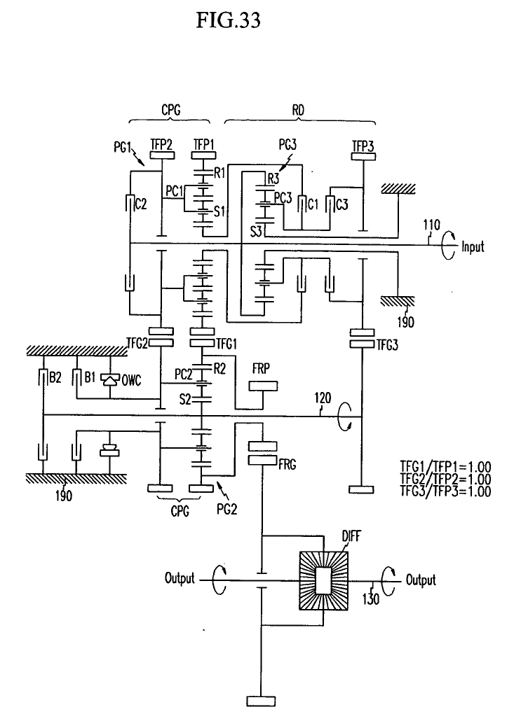

Hereinafter, a powertrain of an automatic transmission according to a twenty-fifth embodiment of the present invention is described in detail with reference to FIG. 33.

As shown in FIG. 33, a powertrain of an automatic transmission according to the twenty-fifth embodiment of the present invention is similar to a powertrain of an automatic transmission according to the first embodiment of the present invention.

That is, a powertrain of an automatic transmission according to the present embodiment includes a primary input shaft 110, a secondary input shaft 120, an output shaft 130, a compound planetary gear set CPG including first and second planetary gear sets PG1 and PG2, and a speed reduction device RD. Regarding a powertrain of an automatic transmission according to the present embodiment, the primary input shaft 110, the secondary input shaft 120, the output shaft 130, and the speed reduction device RD are the same as have been described in connection with a powertrain of an automatic transmission according to the first embodiment of the present invention.

According to the compound planetary gear set CPG (refer to FIG. 1) of the first embodiment, both the first and second planetary gear sets PG1 and PG2 are formed as single pinion planetary gear sets. However, according to the compound planetary gear set CPG of the present embodiment, the first planetary gear set PG1 is formed as a double pinion planetary gear set.

That is, the first planetary gear set PG1 of the compound planetary gear set CPG is a double pinion planetary gear set having a first sun gear S1, a first planet carrier PC1, and a first ring gear R1, and the second planetary gear set PG2 of the compound planetary gear set CPG is a single pinion planetary gear set having a second sun gear S2, a second planet carrier PC2, and a second ring gear R2.

Here, the first ring gear R1 is externally gear-meshed with the second ring gear R2, and the first planet carrier PC1 is externally gear-meshed with the second planet carrier PC2.

That is, external gears TFP1 and TFG1 are respectively formed on exterior circumferences of the first and second ring gears R1 and R2, and the external gears TFP1 and TFG1 are externally gear-meshed with each other. In addition, external gears TFP2 and TFG2 are respectively formed on exterior circumferences of the first and second planet carriers PC1 and PC2, and the external gears TFP2 and TFG2 are externally gear-meshed with each other.

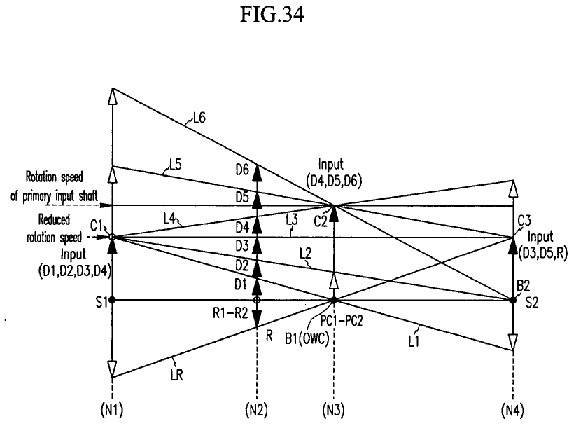

Therefore, the compound planetary gear set CPG of the present embodiment forms first, second, third, and fourth operational elements N1, N2, N3, and N4, as shown in FIG. 34.

That is, as shown in FIG. 34, according to a powertrain of an automatic transmission according to the present embodiment, the first sun gear S1 forms the first operational element N1, the first and second ring gears R1 and R2 externally gear-meshed with each other form the second operational element N2, the first and second planet carriers PC1 and PC2 externally gear-meshed with each other form the third operational element N3, and the second sun gear S2 forms the fourth operational element N4.

According to the present embodiment, the structure of the speed reduction device RD, arrangement of the first, second, and third clutches C1, C2, and C3, and the first and second brakes B1 and B2 are the same as have been described in connection with the first embodiment.

The speed reduction device RD of the present embodiment includes a third planetary gear set PG3, a transfer drive gear TFP3, and a transfer driven gear TFG3. Structure of the third planetary gear set PG3 and connections of planetary gear members of the third planetary gear set PG3 to the compound planetary gear set CPG and primary input shaft 110 are the same as have been described in connection with the first embodiment.

That is, the same as in the first embodiment, a speed reduction device RD of the present embodiment includes a third planetary gear set PG3 disposed on the primary input shaft 110, a transfer drive gear TFP3 disposed on the primary input shaft 110, and a transfer driven gear TFG3 disposed on the secondary input shaft 120 and externally gear-meshed with the transfer drive gear TFP3. The third planetary gear set PG3 is formed as a single pinion planetary gear set having a third sun gear S3, a third planet carrier PC3, and a third ring gear R3. The third sun gear S3 is fixedly connected to the transmission case 190, and the third ring gear R3 is fixedly connected to the primary input shaft. The third planet carrier PC3 is variably connected to the first operational element N1 (i.e., the first sun gear S1) via the first clutch C1. The transfer drive gear TFP3 is variably connected to the third planet carrier PC3 via the third clutch C3, and the transfer driven gear TFG3 is fixed to the secondary input shaft 120.

According to the first embodiment, the second clutch C2 (refer to FIG. 1) variably interconnects the first ring gear R1 and the primary input shaft 110. However, according to the present embodiment, the second clutch C2 variably interconnects the first planet carrier PC1 and the primary input shaft 110.

Therefore, when such a second clutch C2 operates, the first planet carrier PC1 rotates at the same speed as the primary input shaft 110. That is, the same as in the first embodiment, and the third operational element N3 rotates at the rotation speed of the primary input shaft 110 by the operation of the second clutch C2.

Therefore, the same as a powertrain of the first embodiment, a powertrain of an automatic transmission according to the present embodiment may be operated according to the operational chart shown in FIG. 17. In this case, six forward speeds and one reverse speed are realized according to the speed diagram shown in FIG. 34.

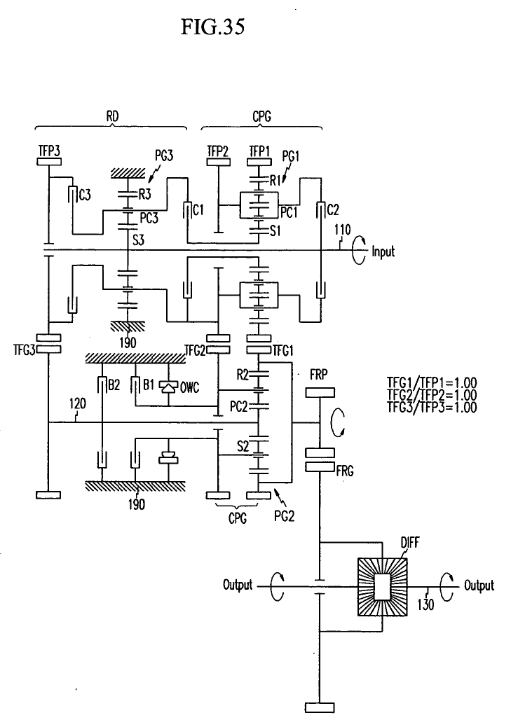

Hereinafter, a powertrain of an automatic transmission according to a twenty-sixth embodiment of the present invention is described in detail with reference to FIG. 35.

As shown in FIG. 35, a powertrain of an automatic transmission according to the twenty-sixth embodiment of the present invention is similar to a powertrain of an automatic transmission according to the twenty-fifth embodiment of the present invention.

The same as a powertrain of the twenty-fifth embodiment, a speed reduction device in a powertrain of the present embodiment includes a third planetary gear set PG3. The third planetary gear set PG3 is formed as a single pinion planetary gear set having a third sun gear S3, a third planet carrier PC3, and a third ring gear R3.

However, the present embodiment is different from the twenty-fifth embodiment in that the third ring gear R3 is fixedly connected to the transmission case 190, and the third sun gear S3 is fixedly connected to the primary input shaft 110.

Arrangement of the first, second, and third clutches C1, C2, and C3 and the first and second brakes B1 and B2 of the present embodiment is the same as in the twenty-fifth embodiment. That is, the third planet carrier PC3 is variably connected to the first sun gear S1 via the first clutch C1, and to the transfer drive gear TFP3 via the third clutch C3. In addition, the transfer driven gear TFG3 is fixedly connected to the secondary input shaft 120.

Such a speed reduction device RD of the present embodiment may also supply a reduced speed to the first operational element N1 (i.e., the first sun gear S1) and the fourth operational element N4 (i.e., the second sun gear S2) through the third planet carrier PC3.

Therefore, the same as in a powertrain of the twenty-fifth embodiment, a powertrain of the present embodiment may be operated according to the operational chart shown in FIG. 17. In this case, six forward speeds and one reverse speed are realized according to the speed diagram shown in FIG. 34.

According to an embodiment of the present invention, planetary gear sets included in a compound planetary gear set and frictional elements for operating the same are dispersedly disposed on primary and secondary input shafts. Therefore, the length of a transmission may be shortened, and accordingly, the transmission may become lightweight and easily installed.

In addition, marginal room is increased in the lengthwise direction. Therefore, frictional elements may be arranged front and rear of planetary gears instead of at the radial exterior thereof, and accordingly, diameters of friction plates may be designed to be smaller. Consequently, frictional loss of frictional elements may be minimized such that efficiency of a transmission may be increased.

In addition, torque is dispersedly transmitted through three external gear engagements, and accordingly, durability of gears is enhanced and noise is reduced.

Furthermore, as shown in an embodiment of the present invention, according to a powertrain of an automatic transmission according to an embodiment of the present invention, a speed reduction device may be disposed to front or rear of a compound planetary gear set, and may also be split to front and rear thereof.

In addition, according to a powertrain of an automatic transmission according to an embodiment of the present invention, a seven-speed powertrain is easily formed by adding one gear and frictional element to a basic layout of a forward six-speed powertrain. An eight-speed powertrain is also easily formed by adding one gear and frictional element to the layout of the seven-speed powertrain.

In this case, length and overall size of such a seven-speed and eight-speed powertrain are almost the same as those of a six-speed powertrain, and accordingly, seven-speed and eight-speed powertrains of an automatic transmission having high installability may be realized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A powertrain of an automatic transmission, comprising:
a primary input shaft;
a secondary input shaft disposed in parallel with the primary input shaft; and
a compound planetary gear set including first and second planetary gear sets respectively disposed on the primary and secondary input shafts and forming a plurality of operational elements by externally gear-meshing a plurality of pairs of operational members of the first and second planetary gear sets.

2. A powertrain of an automatic transmission, comprising:
a primary input shaft;
a secondary input shaft disposed in parallel with the primary input shaft;
an output shaft disposed in parallel with the primary and secondary input shafts;
a compound planetary gear set including first and second planetary gear sets disposed on the primary and secondary input shafts wherein the first and second planetary gear sets are externally gear-meshed with each other so as to form a plurality of operational element including first, second, third, and fourth operational elements;
a speed reduction device reducing a rotation speed of the primary input shaft and selectively transmitting the reduced speed to the second input shaft and an operational member of the compound planetary gear set;
a first clutch for transmitting the reduced speed of the speed reduction device to the first operational element;
a second clutch variably connecting the third operational element and the primary input shaft;
a third clutch for transmitting the reduced speed of the speed reduction device to the secondary input shaft;
a first brake for stopping the third operational element; and
a second brake for stopping the fourth operational element.

3. The powertrain of claim 2, wherein:
the first planetary gear set is a single pinion planetary gear set having a first sun gear, a first planet carrier, and a first ring gear;
the second planetary gear set is a single pinion planetary gear set having a second sun gear, a second planet carrier, and a second ring gear;
the first planet carrier is externally gear-meshed with the second ring gear; and
the first ring gear is externally gear-meshed with the second planet carrier.

4. The powertrain of claim 3, wherein:
the first sun gear forms the first operational element;
the first planet carrier and the second ring gear form the second operational element;
the first ring gear and the second planet carrier form the third operational element; and
the second sun gear forms the fourth operational element.

5. The powertrain of claim 2, wherein the speed reduction device comprises:
a third planetary gear set disposed on the primary input shaft and including a fixed element fixed to the transmission case, an input element receiving rotation speed of the primary input shaft, and an output element outputting reduced speed by interaction with the fixed element and the input element;
a transfer drive gear disposed on the primary input shaft; and
a transfer driven gear disposed on the secondary input shaft and externally gear-meshed with the transfer drive gear.

6. The powertrain of claim 5, wherein:
the third planetary gear set is a single pinion planetary gear set having a third sun gear, a third ring gear, and a third planet carrier;
the third sun gear, the third ring gear, and the third planet carrier respectively act as the fixed element, the input element, and the output element; and
the third planet carrier is variably connected to the first operational element via the first clutch.

7. The powertrain of claim 5, wherein:
the third clutch variably connects the output element and the transfer drive gear; and
the transfer driven gear is fixed to the secondary input shaft.

8. The powertrain of claim 5, wherein:
the transfer drive gear is fixedly connected to the output element; and
the third clutch variably connects the transfer driven gear and the secondary input shaft.

9. The powertrain of claim 5, wherein the transfer drive gear and the third planetary gear set are disposed opposite to each other with respect to the first planetary gear set.

10. The powertrain of claim 9, wherein the transfer drive gear and the transfer driven gear form a predetermined reduction ratio by a radius ratio thereof.

11. The powertrain of claim 10, wherein:
the third clutch variably connects the primary input shaft and the transfer drive gear; and
the transfer driven gear is fixed to the secondary input shaft.

12. The powertrain of claim 5, wherein:
the speed reduction device further comprises a fourth planetary gear set disposed on the secondary input shaft and externally gear-meshed with the transfer drive gear; and
the third clutch variably connects the primary input shaft and the transfer drive gear.

13. The powertrain of claim 12, wherein:
the fourth planetary gear set is a single pinion planetary gear set;
a sun gear of the fourth planetary gear set is fixedly connected to the transmission case;
a planet carrier of the fourth planetary gear set is fixedly connected to the secondary input shaft; and
a ring gear of the fourth planetary gear set forms the transfer driven gear on an exterior circumference thereof.

14. The powertrain of claim 5, wherein:
the third planetary gear set is a single pinion planetary gear set having a third sun gear, a third ring gear, and a third planet carrier;
the third sun gear, the third ring gear, and the third planet carrier respectively act as the input element, the fixed element and the output element; and
the third planet carrier is variably connected to the first operational element via the first clutch.

15. The powertrain of claim 5, wherein:
the third planetary gear set is a double pinion planetary gear set having a third sun gear, a third ring gear, and a third planet carrier;
the third sun gear, the third ring gear, and the third planet carrier respectively act as an input element, an output element, and a fixed element; and
the third ring gear is variably connected to the first operational element via the first clutch.

16. The powertrain of claim 5, wherein:
the third planetary gear set is a double pinion planetary gear set having a third sun gear, a third ring gear, and a third planet carrier;
the third sun gear, the third ring gear, and the third planet carrier respectively act as the fixed element, the output element, and the input element; and
the third ring gear is variably connected to the first operational element via the first clutch.

17. The powertrain of claim 5, further comprising:
a final drive gear for outputting rotation speed of an operational member of the compound planetary gear set; and
a final driven gear for driving a differential by being disposed on the output shaft and being engaged with the final drive gear.

18. The powertrain of claim 17, further comprising:
a first output mediating gear disposed on the output shaft and externally gear-meshed with one of the transfer driven gear and the third operational element; and
a fourth clutch variably connecting the first output mediating gear and the final driven gear.

19. The powertrain of claim 18, wherein the first output mediating gear is engaged with the transfer driven gear.

20. The powertrain of claim 19, further comprising:
a second output mediating gear disposed on the output shaft and externally gear-meshed with the third operational element; and
a fifth clutch variably connecting the second output mediating gear and the final driven gear.

21. The powertrain of claim 2, wherein the speed reduction device comprises:
a transfer drive gear disposed on the primary input shaft;
a transfer driven gear disposed on the secondary input shaft and externally gear-meshed with the transfer drive gear;
a mediating drive gear disposed on the secondary input shaft and fixedly connected to the transfer driven gear; and
a mediating driven gear disposed on the primary input shaft and externally gear-meshed with the mediating drive gear,
wherein
the first clutch variably connects the mediating driven gear and the first operational element, and
the third clutch variably connects the secondary input shaft and one of the transfer driven gear and the mediating drive gear.

22. The powertrain of claim 21, further comprising:
a final drive gear for outputting rotation speed of an operational member of the compound planetary gear set; and
a final driven gear for driving a differential by being disposed on the output shaft and being engaged with the final drive gear.

23. The powertrain of claim 22, further comprising:
a first output mediating gear disposed on the output shaft and externally gear-meshed with one of the transfer driven gear and the mediating drive gear; and
a fourth clutch variably connecting the first output mediating gear and the final driven gear.

24. The powertrain of claim 23, wherein the first output mediating gear is engaged with the mediating drive gear.

25. The powertrain of claim 24, further comprising:
a second output mediating gear disposed on the output shaft and externally gear-meshed with the transfer driven gear; and
a fifth clutch variably connecting the second output mediating gear and the final driven gear.

26. The powertrain of claim 2, wherein the speed reduction device comprises:
a transfer drive gear disposed on the primary input shaft;
a mediating driven gear disposed on the primary input shaft; and
a fourth planetary gear set forming a transfer driven gear and a mediating drive gear, the transfer driven gear being disposed on the secondary input shaft and externally gear-meshed with the transfer drive gear, the mediating drive gear being externally gear-meshed with the mediating driven gear,
wherein the first clutch variably connects the mediating driven gear and the first operational element.

27. The powertrain of claim 26, wherein:
the fourth planetary gear set is a single pinion planetary gear set;
a sun gear of the fourth planetary gear set is fixedly connected to the transmission case;
a planet carrier of the fourth planetary gear set protrudes in a radial direction so as to form the mediating drive gear;
a ring gear of the fourth planetary gear set forms the transfer driven gear on an exterior circumference thereof; and
the third clutch variably connects the mediating drive gear and the secondary input shaft.

28. The powertrain of claim 26, further comprising:
a final drive gear for outputting rotation speed of an operational member of the compound planetary gear set; and
a final driven gear for driving a differential by being disposed on the output shaft and being engaged with the final drive gear.

29. The powertrain of claim 28, further comprising:
a first output mediating gear disposed on the output shaft and externally gear-meshed with the mediating drive gear; and
a fourth clutch variably connecting the first output mediating gear and the final driven gear.

30. The powertrain of claim 29, wherein:
a second output mediating gear is disposed on the output shaft and is externally gear-meshed with the transfer driven gear; and
a fifth clutch is variably connected to the second output mediating gear and the final driven gear.

31. The powertrain of claim 2, wherein:
the first planetary gear set is a double pinion planetary gear set having a first sun gear, a first planet carrier, and a first ring gear;
the second planetary gear set is a single pinion planetary gear set having a second sun gear, a second planet carrier, and a second ring gear;
the first ring gear is externally gear-meshed with the second ring gear; and
the first planet carrier is externally gear-meshed with the second planet carrier.

32. The powertrain of claim 31, wherein:
the first sun gear forms the first operational element;
the first and second ring gears form the second operational element;
the first and second planet carriers form the third operational element; and
the second sun gear forms the fourth operational element.

33. The powertrain of claim 31, wherein the speed reduction device comprises:
a third planetary gear set disposed on the primary input shaft;
a transfer drive gear disposed on the primary input shaft; and
a transfer driven gear disposed on the secondary input shaft and externally gear-meshed with the transfer drive gear.

34. The powertrain of claim 33, wherein the third planetary gear set is a single pinion planetary gear set and comprises:
a third sun gear fixedly connected to the transmission case;
a third ring gear fixedly connected to the primary input shaft; and
a third planet carrier variably connected to the first operational element via the first clutch.

35. The powertrain of claim 34, wherein:
the third clutch variably connects the third planet carrier and the transfer drive gear; and
the transfer driven gear is fixed to the secondary input shaft.

36. The powertrain of claim 33, wherein the third planetary gear set is a single pinion planetary gear set and includes:
a third ring gear fixedly connected to the transmission case;
a third sun gear fixedly connected to the primary input shaft; and
a third planet carrier variably connected to the first operational element via the first clutch.

37. The powertrain of claim 36, wherein:
the third clutch variably interconnects the third planet carrier and the transfer drive gear; and
the transfer driven gear is fixed to the secondary input shaft.
